(19) United States
(12) Patent Application Publication
(10) Pub. No.: US 2024/0340152 A1
(43) Pub. Date: Oct. 10, 2024

(54) USER EQUIPMENTS, BASE STATIONS AND METHODS FOR BEAM INDICATION WITH INTER-CELL MOBILITY FOR PDCCH

(71) Applicant: SHARP KABUSHIKI KAISHA, Sakai City, Osaka (JP)

(72) Inventors: KAI YING, Vancouver, WA (US); KAZUNARI YOKOMAKURA, Sakai City, Osaka (JP); ZHANPING YIN, Vancouver, WA (US)

(21) Appl. No.: 18/293,902

(22) PCT Filed: Jun. 29, 2022
(86) PCT No.: PCT/JP2022/026119

§ 371 Date: Jan. 31, 2024

Related U.S. Application Data
(60) Provisional application No. 63/229,984, filed on Aug. 5, 2021.

(51) Int. Cl. H04L 5/00

(52) U.S. Cl. CPC H04L 5/0094; H04L 5/0051

(57) ABSTRACT

A user equipment (UE) that communicates with a base station apparatus is described. The UE may include receiving circuitry configured to receive a radio resource control (RRC) message comprising first information used for indicating a first list of Transmission Configuration Indicator (TCI) state(s) for beam(s) associated with non-serving cell(s), and receive an RRC message comprising second information used for indicating a second list of Transmission Configuration Indicator (TCI) state(s) for beam(s) associated with serving cell(s), and receive a first media access control (MAC) Control Element (CE) message comprising third information used for indicating a first TCI state for physical downlink control channel (PDCCH) from the first list. Further, the receiving circuitry may also be configured to receive a second media access control (MAC) Control Element (CE) message comprising fourth information used for indicating a second TCI state for physical downlink control channel (PDCCH) from the second list.

### CROSS REFERENCE

This Nonprovisional application claims priority under 35 U.S.C. § 119 on provisional Application No. 63/229,984 on Aug. 5, 2021, the entire contents of which are hereby incorporated by reference.

### TECHNICAL FIELD

The present disclosure relates generally to communication systems. More specifically, the present disclosure relates to user equipments, base stations and methods for beam management with inter-cell mobility.

### BACKGROUND ART

Wireless communication devices have become smaller and more powerful in order to meet consumer needs and to improve portability and convenience. Consumers have become dependent upon wireless communication devices and have come to expect reliable service, expanded areas of coverage and increased functionality. A wireless communication system may provide communication for a number of wireless communication devices, each of which may be serviced by a base station. A base station may be a device that communicates with wireless communication devices.

As wireless communication devices have advanced, improvements in communication capacity, speed, flexibility and/or efficiency have been sought. However, improving communication capacity, speed, flexibility and/or efficiency may present certain problems.

For example, wireless communication devices may communicate with one or more devices using a communication structure. However, the communication structure used may only offer limited flexibility and/or efficiency. As illustrated by this discussion, systems and methods that improve communication flexibility and/or efficiency may be beneficial.

### SUMMARY OF INVENTION

In one example, a user equipment (UE) that communicates with a base station apparatus, comprising: receiving circuitry configured to: receive a radio resource control (RRC) message comprising first information used for indicating a first list of Transmission Configuration Indicator (TCI) state(s) for beam(s) associated with non-serving cell(s); receive an RRC message comprising second information used for indicating a second list of Transmission Configuration Indicator (TCI) state(s) for beam(s) associated with serving cell(s); receive a first media access control (MAC) Control Element (CE) message comprising third information used for indicating a first TCI state for physical downlink control channel (PDCCH) from the first list; and receive a second media access control (MAC) Control Element (CE) message comprising fourth information used for indicating a second TCI state for physical downlink control channel (PDCCH) from the second list.

In one example, a base station apparatus that communicates with a user equipment (UE), comprising: transmitting circuitry configured to: transmit a radio resource control (RRC) message comprising first information used for indicating a first list of Transmission Configuration Indicator (TCI) state(s) for beam(s) associated with non-serving cell(s); transmit an RRC message comprising second information used for indicating a second list of Transmission Configuration Indicator (TCI) state(s) for beam(s) associated with serving cell(s); transmit a first media access control (MAC) Control Element (CE) message comprising third information used for indicating a first TCI state for physical downlink control channel (PDCCH) from the first list; and transmit a second media access control (MAC) Control Element (CE) message comprising fourth information used for indicating a second TCI state for physical downlink control channel (PDCCH) from the second list.

In one example, a communication method of a user equipment (UE) that communicates with a base station apparatus, comprising: receiving a radio resource control (RRC) message comprising first information used for indicating a first list of Transmission Configuration Indicator (TCI) state(s) for beam(s) associated with non-serving cell(s); receiving an RRC message comprising second information used for indicating a second list of Transmission Configuration Indicator (TCI) state(s) for beam(s) associated with serving cell(s); receiving a first media access control (MAC) Control Element (CE) message comprising third information used for indicating a first TCI state for physical downlink control channel (PDCCH) from the first list; receiving a second media access control (MAC) Control Element (CE) message comprising fourth information used for indicating a second TCI state for physical downlink control channel (PDCCH) from the second list; receiving a radio resource control (RRC) message comprising fifth information used for indicating a third list of Transmission Configuration Indicator (TCI) state(s) for beam(s) associated with non-serving cell(s) and/or Transmission Configuration Indicator (TCI) state(s) for beam(s) associated with serving cell(s); and receiving a third media access control (MAC) Control Element (CE) message comprising sixth information used for indicating a third TCI state for physical downlink control channel (PDCCH) from the third list.

### BRIEF DESCRIPTION OF DRAWINGS

FIG. 1 is a block diagram illustrating one implementation of one or more g Node Bs (gNBs) and one or more user equipment (UEs) in which systems and methods for signaling may be implemented.

FIG. 2 shows examples of multiple numerologies.

FIG. 3 is a diagram illustrating one example of a resource grid and resource block.

FIG. 4 shows examples of resource regions.

FIG. 5 illustrates an example of beamforming and quasi-colocation (QCL) type.

FIG. 6 illustrates an example of transmission configuration indication (TCI) states.

FIG. 7 is a flow diagram illustrating an example of a method for joint beam management.

FIG. 8 is a flow diagram illustrating an example of a method for joint beam management.

FIG. 9 illustrates various components that may be utilized in a UE.

FIG. 10 illustrates various components that may be utilized in a gNB.

FIG. 11 is a block diagram illustrating one implementation of a UE in which one or more of the systems and/or methods described herein may be implemented.

FIG. 12 is a block diagram illustrating one implementation of a gNB in which one or more of the systems and/or methods described herein may be implemented.

FIG. 13 is a block diagram illustrating one implementation of a gNB.

FIG. 14 is a block diagram illustrating one implementation of a UE.

FIG. 15 is a flow diagram illustrating an example of a method of a UE for beam management with inter-cell mobility.

FIG. 16 is a flow diagram illustrating an example of a method of a base station for beam management with inter-cell mobility.

FIG. 17 is a flow diagram illustrating an example of a method of a UE for beam indication with inter-cell mobility for PDSCH.

FIG. 18 is a flow diagram illustrating an example of a method of a base station for beam indication with inter-cell mobility for PDSCH.

FIG. 19 is a flow diagram illustrating an example of a method of a UE for beam indication with inter-cell mobility for PDCCH.

FIG. 20 is a flow diagram illustrating an example of a method of a base station for beam indication with inter-cell mobility for PDCCH.

### DESCRIPTION OF EMBODIMENTS

A user equipment (UE) that communicates with a base station apparatus is described. The UE may include receiving circuitry configured to receive a radio resource control (RRC) message comprising first information used for indicating multi-beam measurement/reporting enhancements for L1/L2-centric inter-cell mobility and inter-cell multiple Transmission Reception Points (mTRP) is enabled. The receiving circuitry may also be configured to receive an RRC message comprising second information used for indicating a maximum total number (K) of beams associated with all corresponding non-serving cells reported in a single Channel State Information (CSI) reporting instance. The UE may also include transmitting circuitry configured to transmit, to the base station, a CSI report.

In case that periodic CSI reporting is configured, the number of CSI Reference Signal (CSI-RS) Resources corresponding to beam(s) associated with all non-serving cells in each CSI-RS Resource Set configuration is not expected to be more than K.

In case that semi-persistent CSI reporting on physical uplink control channel (PUCCH) is configured, the number of CSI Reference Signal (CSI-RS) Resources corresponding to beam(s) associated with all non-serving cells in each CSI-RS Resource Set configuration is not expected to be more than K.

In case that semi-persistent CSI reporting on physical uplink share channel (PUSCH) is configured, the number of CSI Reference Signal (CSI-RS) Resources corresponding to beam(s) associated with all non-serving cells in each trigger state configuration is not expected to be more than K.

In case that aperiodic CSI reporting is configured, the number of CSI Reference Signal (CSI-RS) Resources corresponding to beam(s) associated with all non-serving cells in each trigger state configuration is not expected to be more than K.

A base station apparatus that communicates with a user equipment (UE) is described. The base station may include transmitting circuitry configured to transmit a radio resource control (RRC) message comprising first information used for indicating multi-beam measurement/reporting enhancements for L1/L2-centric inter-cell mobility and inter-cell mTRP is enabled. The transmitting circuitry may also be configured to transmit an RRC message comprising second information used for indicating a maximum total number (K) of beams associated with all corresponding non-serving cells reported in a single Channel State Information (CSI) reporting instance. The base station may also include receiving circuitry configured to receive, from the UE, a CSI report.

A communication method of a user equipment (UE) that communicates with a base station apparatus is described. The communication method may include receiving a radio resource control (RRC) message comprising first information used for indicating multi-beam measurement/reporting enhancements for L1/L2-centric inter-cell mobility and inter-cell mTRP is enabled. The communication method may also include receiving an RRC message comprising second information used for indicating a maximum total number (K) of beams associated with all corresponding non-serving cells reported in a single Channel State Information (CSI) reporting instance. Further, the communication method may also include transmitting, to the base station, a CSI report.

A communication method of a base station apparatus that communicates with a user equipment (UE) is described. The communication method may include a transmitting a radio resource control (RRC) message comprising first information used for indicating multi-beam measurement/reporting enhancements for L1/L2-centric inter-cell mobility and inter-cell mTRP is enabled. The communication method may also include transmitting an RRC message comprising second information used for indicating a maximum total number (K) of beams associated with all corresponding non-serving cells reported in a single Channel State Information (CSI) reporting instance. Further, the communication method may receive, from the UE, a CSI report.

A user equipment (UE) that communicates with a base station apparatus is described. The UE may include receiving circuitry configured to receive a radio resource control (RRC) message comprising first information used for indicating a first list of Transmission Configuration Indicator (TCI) state(s) for beam(s) associated with non-serving cell(s). The receiving circuitry may also be configured to receive an RRC message comprising second information used for indicating a second list of Transmission Configuration Indicator (TCI) state(s) for beam(s) associated with serving cell(s). The receiving circuitry may also be configured to receive a first media access control (MAC) Control Element (CE) message comprising third information used for activating a first set of TCI state(s) from the first list. The receiving circuitry may also be configured to receive a second media access control (MAC) Control Element (CE) message comprising fourth information used for activating a second set of TCI state(s) from the second list. Further, the receiving circuitry may also be configured to receive a physical downlink control channel (PDCCH) carrying downlink control information (DCI) indicating a TCI state for physical downlink share channel (PDSCH) from either the first set or the second set.

In some examples, whether the first set or the second set is used may be determined by radio network temporary identifier (RNTI) scrambling cyclic redundancy check (CRC) of the DCI. Whether the first set or the second set is used may also be determined by a format of the DCI.

In other examples, whether the first set or the second set is used may be determined by control resource set (CORESET) where the PDCCH carrying the DCI is detected. Whether the first set or the second set is used may also be determined by search space where the PDCCH carrying the DCI is detected.

A base station apparatus that communicates with a user equipment (UE) is described. The base station may include transmitting circuitry configured to transmit a radio resource control (RRC) message comprising first information used for indicating a first list of Transmission Configuration Indicator (TCI) state(s) for beam(s) associated with non-serving cell(s). The transmitting circuitry may also be configured to transmit an RRC message comprising second information used for indicating a second list of Transmission Configuration Indicator (TCI) state(s) for beam(s) associated with serving cell(s). The transmitting circuitry may also be configured to transmit a first media access control (MAC) Control Element (CE) message comprising third information used for activating a first set of TCI state(s) from the first list. The transmitting circuitry may also be configured to transmit a second media access control (MAC) Control Element (CE) message comprising fourth information used for activating a second set of TCI state(s) from the second list. Further, the transmitting circuitry may also be configured to transmit a physical downlink control channel (PDCCH) carrying downlink control information (DCI) indicating a TCI state for physical downlink share channel (PDSCH) from either the first set or the second set.

A communication method of a user equipment (UE) that communicates with a base station apparatus is described. The communication method may include receiving a radio resource control (RRC) message comprising first information used for indicating a first list of Transmission Configuration Indicator (TCI) state(s) for beam(s) associated with non-serving cell(s). The communication method may also include receiving an RRC message comprising second information used for indicating a second list of Transmission Configuration Indicator (TCI) state(s) for beam(s) associated with serving cell(s). The communication method may also include receiving a first media access control (MAC) Control Element (CE) message comprising third information used for activating a first set of TCI state(s) from the first list. The communication method may also include receiving a second media access control (MAC) Control Element (CE) message comprising fourth information used for activating a second set of TCI state(s) from the second list. Further, the communication method may also include receiving a physical downlink control channel (PDCCH) carrying downlink control information (DCI) indicating a TCI state for physical downlink share channel (PDSCH) from either the first set or the second set.

A communication method of a base station apparatus that communicates with a user equipment (UE) is described. The communication method may include transmitting a radio resource control (RRC) message comprising first information used for indicating a first list of Transmission Configuration Indicator (TCI) state(s) for beam(s) associated with non-serving cell(s). The communication method may also include transmitting an RRC message comprising second information used for indicating a second list of Transmission Configuration Indicator (TCI) state(s) for beam(s) associated with serving cell(s). The communication method may include transmitting a first media access control (MAC) Control Element (CE) message comprising third information used for activating a first set of TCI state(s) from the first list. The communication method may include transmitting a second media access control (MAC) Control Element (CE) message comprising fourth information used for activating a second set of TCI state(s) from the second list. Further, the communication method may include transmitting a physical downlink control channel (PDCCH) carrying downlink control information (DCI) indicating a TCI state for physical downlink share channel (PDSCH) from either the first set or the second set.

A user equipment (UE) that communicates with a base station apparatus is described. The UE may include receiving circuitry configured to receive a radio resource control (RRC) message comprising first information used for indicating a first list of Transmission Configuration Indicator (TCI) state(s) for beam(s) associated with non-serving cell(s). The receiving circuitry may also be configured to receive an RRC message comprising second information used for indicating a second list of Transmission Configuration Indicator (TCI) state(s) for beam(s) associated with serving cell(s). The receiving circuitry may also be configured to receive a first media access control (MAC) Control Element (CE) message comprising third information used for indicating a first TCI state for physical downlink control channel (PDCCH) from the first list. Further, the receiving circuitry may also be configured to receive a second media access control (MAC) Control Element (CE) message comprising fourth information used for indicating a second TCI state for physical downlink control channel (PDCCH) from the second list.

A base station apparatus that communicates with a user equipment (UE) is described. The base station may include transmitting circuitry configured to transmit a radio resource control (RRC) message comprising first information used for indicating a first list of Transmission Configuration Indicator (TCI) state(s) for beam(s) associated with non-serving cell(s). The transmitting circuitry may also be configured to transmit an RRC message comprising second information used for indicating a second list of Transmission Configuration Indicator (TCI) state(s) for beam(s) associated with serving cell(s). The transmitting circuitry may also be configured to transmit a first media access control (MAC) Control Element (CE) message comprising third information used for indicating a first TCI state for physical downlink control channel (PDCCH) from the first list. The transmitting circuitry may also be configured to transmit a second media access control (MAC) Control Element (CE) message comprising fourth information used for indicating a second TCI state for physical downlink control channel (PDCCH) from the second list.

A communication method of a user equipment (UE) that communicates with a base station apparatus is described. The communication method may include receiving a radio resource control (RRC) message comprising first information used for indicating a first list of Transmission Configuration Indicator (TCI) state(s) for beam(s) associated with non-serving cell(s). The communication method may also include receiving an RRC message comprising second information used for indicating a second list of Transmission Configuration Indicator (TCI) state(s) for beam(s) associated with serving cell(s). The communication method may also include receiving a first media access control (MAC) Control Element (CE) message comprising third information used for indicating a first TCI state for physical downlink control channel (PDCCH) from the first list. The communication method may also include receiving a second media access control (MAC) Control Element (CE) message comprising fourth information used for indicating a second TCI state for physical downlink control channel (PDCCH) from the second list.

A communication method of a base station apparatus that communicates with a user equipment (UE) is described. The communication method may include transmitting a radio resource control (RRC) message comprising first information used for indicating a first list of Transmission Configuration Indicator (TCI) state(s) for beam(s) associated with non-serving cell(s). The communication method may also include transmitting an RRC message comprising second information used for indicating a second list of Transmission Configuration Indicator (TCI) state(s) for beam(s) associated with serving cell(s). The communication method may also include transmitting a first media access control (MAC) Control Element (CE) message comprising third information used for indicating a first TCI state for physical downlink control channel (PDCCH) from the first list. The communication method may also include transmitting a second media access control (MAC) Control Element (CE) message comprising fourth information used for indicating a second TCI state for physical downlink control channel (PDCCH) from the second list.

A user equipment (UE) that communicates with a base station apparatus is described. The UE may include receiving circuitry configured to receive a radio resource control (RRC) message comprising first information used for indicating a first list of Transmission Configuration Indicator (TCI) state(s) for beam(s) associated with non-serving cell(s) and/or Transmission Configuration Indicator (TCI) state(s) for beam(s) associated with serving cell(s). The receiving circuitry may also be configured to receive a first media access control (MAC) Control Element (CE) message comprising third information used for indicating a first TCI state for physical downlink control channel (PDCCH) from the first list.

A base station apparatus that communicates with a user equipment (UE) is described. The base station may include transmitting circuitry configured to transmit a radio resource control (RRC) message comprising first information used for indicating a first list of Transmission Configuration Indicator (TCI) state(s) for beam(s) associated with non-serving cell(s) and/or Transmission Configuration Indicator (TCI) state(s) for beam(s) associated with serving cell(s). The transmitting circuitry may also be configured to transmit a first media access control (MAC) Control Element (CE) message comprising third information used for indicating a first TCI state for physical downlink control channel (PDCCH) from the first list.

A communication method of a user equipment (UE) that communicates with a base station apparatus is described. The communication method may include receiving a radio resource control (RRC) message comprising first information used for indicating a first list of Transmission Configuration Indicator (TCI) state(s) for beam(s) associated with non-serving cell(s) and/or Transmission Configuration Indicator (TCI) state(s) for beam(s) associated with serving cell(s). The communication method may also include receiving a first media access control (MAC) Control Element (CE) message comprising third information used for indicating a first TCI state for physical downlink control channel (PDCCH) from the first list.

A communication method of a base station apparatus that communicates with a user equipment (UE) is described. The communication method may include transmitting a radio resource control (RRC) message comprising first information used for indicating a first list of Transmission Configuration Indicator (TCI) state(s) for beam(s) associated with non-serving cell(s) and/or Transmission Configuration Indicator (TCI) state(s) for beam(s) associated with serving cell(s). The communication method may also include transmitting a first media access control (MAC) Control Element (CE) message comprising third information used for indicating a first TCI state for physical downlink control channel (PDCCH) from the first list.

The 3rd Generation Partnership Project, also referred to as “3GPP,” is a collaboration agreement that aims to define globally applicable technical specifications and technical reports for third and fourth generation wireless communication systems. The 3GPP may define specifications for next generation mobile networks, systems and devices.

3GPP Long Term Evolution (LTE) is the name given to a project to improve the Universal Mobile Telecommunications System (UMTS) mobile phone or device standard to cope with future requirements. In one aspect, UMTS has been modified to provide support and specification for the Evolved Universal Terrestrial Radio Access (E-UTRA) and Evolved Universal Terrestrial Radio Access Network (E-UTRAN).

At least some aspects of the systems and methods disclosed herein may be described in relation to the 3GPP LTE, LTE-Advanced (LTE-A), LTE-Advanced Pro and other standards (e.g., 3GPP Releases 8, 9, 10, 11, 12, 13, 14, 15, and/or 16). However, the scope of the present disclosure should not be limited in this regard. At least some aspects of the systems and methods disclosed herein may be utilized in other types of wireless communication systems.

A wireless communication device may be an electronic device used to communicate voice and/or data to a base station, which in turn may communicate with a network of devices (e.g., public switched telephone network (PSTN), the Internet, etc.). In describing systems and methods herein, a wireless communication device may alternatively be referred to as a mobile station, a UE, an access terminal, a subscriber station, a mobile terminal, a remote station, a user terminal, a terminal, a subscriber unit, a mobile device, etc. Examples of wireless communication devices include cellular phones, smart phones, personal digital assistants (PDAs), laptop computers, netbooks, e-readers, wireless modems, etc. In 3GPP specifications, a wireless communication device is typically referred to as a UE. However, as the scope of the present disclosure should not be limited to the 3GPP standards, the terms “UE” and “wireless communication device” may be used interchangeably herein to mean the more general term “wireless communication device.” A UE may also be more generally referred to as a terminal device.

In 3GPP specifications, a base station is typically referred to as a Node B, an evolved Node B (eNB), a home enhanced or evolved Node B (HeNB), a g Node B (gNB) or some other similar terminology. As the scope of the disclosure should not be limited to 3GPP standards, the terms “base station,” “Node B,” “eNB,” “gNB” and “HeNB” may be used interchangeably herein to mean the more general term “base station.” Furthermore, the term “base station” may be used to denote an access point. An access point may be an electronic device that provides access to a network (e.g., Local Area Network (LAN), the Internet, etc.) for wireless communication devices. The term “communication device” may be used to denote both a wireless communication device and/or a base station. An gNB may also be more generally referred to as a base station device.

It should be noted that as used herein, a “cell” may be any communication channel that is specified by standardization or regulatory bodies to be used for International Mobile Telecommunications-Advanced (IMT-Advanced) or IMT-2020, and all of it or a subset of it may be adopted by 3GPP as licensed bands or unlicensed bands (e.g., frequency bands) to be used for communication between an eNB or gNB and a UE. It should also be noted that in E-UTRA and E-UTRAN overall description, as used herein, a “cell” may be defined as “combination of downlink and optionally uplink resources.” The linking between the carrier frequency of the downlink resources and the carrier frequency of the uplink resources may be indicated in the system information transmitted on the downlink resources.

The 5th generation communication systems, dubbed NR (New Radio technologies) by 3GPP, envision the use of time/frequency/space resources to allow for services, such as eMBB (enhanced Mobile Broad-Band) transmission, URLLC (Ultra Reliable and Low Latency Communication) transmission, and mMTC (massive Machine Type Communication) transmission. And, in NR, transmissions for different services may be specified (e.g., configured) for one or more bandwidth parts (BWPs) in a serving cell and/or for one or more serving cells. A user equipment (UE) may receive a downlink (DL) signal(s) and/or transmit an uplink signal(s) in the BWP(s) of the serving cell and/or the serving cell(s).

In order for the services to use the time, frequency, and/or spatial resources efficiently, it would be useful to be able to efficiently control downlink and/or uplink transmissions. Therefore, a procedure for efficient control of downlink and/or uplink transmissions should be designed. Accordingly, a detailed design of a procedure for downlink and/or uplink transmissions may be beneficial.

Various examples of the systems and methods disclosed herein are now described with reference to the Figures, where like reference numbers may indicate functionally similar elements. The systems and methods as generally described and illustrated in the Figures herein could be arranged and designed in a wide variety of different implementations. Thus, the following more detailed description of several implementations, as represented in the Figures, is not intended to limit scope, as claimed, but is merely representative of the systems and methods.

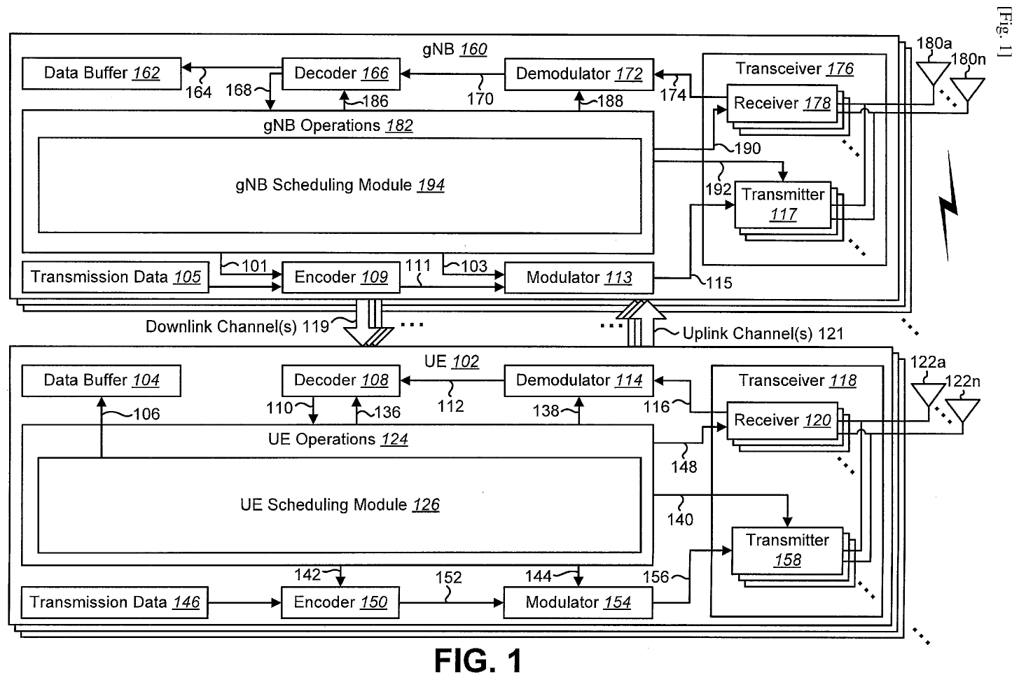

FIG. 1 is a block diagram illustrating one implementation of one or more gNBs 160 and one or more UEs 102 in which systems and methods for signaling (and/or joint beam management) may be implemented. The one or more UEs 102 communicate with one or more gNBs 160 using one or more physical antennas 122a-n. For example, a UE 102 transmits electromagnetic signals to the gNB 160 and receives electro-magnetic signals from the gNB 160 using the one or more physical antennas 122a-n. The gNB 160 communicates with the UE 102 using one or more physical antennas 180a-n. In some implementations, the term “base station,” “eNB,” and/or “gNB” may refer to and/or may be replaced by the term “Transmission Reception Point (TRP).” For example, the gNB 160 described in connection with FIG. 1 may be a TRP in some implementations.

The UE 102 and the gNB 160 may use one or more channels and/or one or more signals 119, 121 to communicate with each other. For example, the UE 102 may transmit information or data to the gNB 160 using one or more uplink channels 121. Examples of uplink channels 121 include a physical shared channel (e.g., PUSCH (physical uplink shared channel)) and/or a physical control channel (e.g., PUCCH (physical uplink control channel)), etc. The one or more gNBs 160 may also transmit information or data to the one or more UEs 102 using one or more downlink channels 119, for instance. Examples of downlink channels 119 include a physical shared channel (e.g., PDSCH (physical downlink shared channel) and/or a physical control channel (PDCCH (physical downlink control channel)), etc. Other kinds of channels and/or signals may be used.

Each of the one or more UEs 102 may include one or more transceivers 118, one or more demodulators 114, one or more decoders 108, one or more encoders 150, one or more modulators 154, a data buffer 104 and a UE operations module 124. For example, one or more reception and/or transmission paths may be implemented in the UE 102. For convenience, only a single transceiver 118, decoder 108, demodulator 114, encoder 150 and modulator 154 are illustrated in the UE 102, though multiple parallel elements (e.g., transceivers 118, decoders 108, demodulators 114, encoders 150 and modulators 154) may be implemented.

The transceiver 118 may include one or more receivers 120 and one or more transmitters 158. The one or more receivers 120 may receive signals from the gNB 160 using one or more antennas 122a-n. For example, the receiver 120 may receive and downconvert signals to produce one or more received signals 116. The one or more received signals 116 may be provided to a demodulator 114. The one or more transmitters 158 may transmit signals to the gNB 160 using one or more physical antennas 122a-n. For example, the one or more transmitters 158 may upconvert and transmit one or more modulated signals 156.

The demodulator 114 may demodulate the one or more received signals 116 to produce one or more demodulated signals 112. The one or more demodulated signals 112 may be provided to the decoder 108. The UE 102 may use the decoder 108 to decode signals. The decoder 108 may produce decoded signals 110, which may include a UE-decoded signal 106 (also referred to as a first UE-decoded signal 106). For example, the first UE-decoded signal 106 may comprise received payload data, which may be stored in a data buffer 104. Another signal included in the decoded signals 110 (also referred to as a second UE-decoded signal 110) may comprise overhead data and/or control data. For example, the second UE-decoded signal 110 may provide data that may be used by the UE operations module 124 to perform one or more operations.

In general, the UE operations module 124 may enable the UE 102 to communicate with the one or more gNBs 160. The UE operations module 124 may include a UE scheduling module 126.

The UE scheduling module 126 may perform downlink reception(s) and uplink transmission(s). The downlink reception(s) include reception of data, reception of downlink control information, and/or reception of downlink reference signals. Also, the uplink transmissions include transmission of data, transmission of uplink control information, and/or transmission of uplink reference signals.

Also, in a carrier aggregation (CA), the gNB 160 and the UE 102 may communicate with each other using one or more serving cells. Here the one or more serving cells may include one primary cell and one or more secondary cells. For example, the gNB 160 may transmit, by using the RRC message, information used for configuring one or more secondary cells to form together with the primary cell a set of serving cells. Namely, the set of serving cells may include one primary cell and one or more secondary cells. Here, the primary cell may be always activated. Also, the gNB 160 may activate one or more secondary cell within the configured secondary cells. Here, in the downlink, a carrier corresponding to the primary cell may be the downlink primary component carrier (i.e., the DL PCC), and a carrier corresponding to a secondary cell may be the downlink secondary component carrier (i.e., the DL SCC). Also, in the uplink, a carrier corresponding to the primary cell may be the uplink primary component carrier (i.e., the UL PCC), and a carrier corresponding to the secondary cell may be the uplink secondary component carrier (i.e., the UL SCC).

In a radio communication system, physical channels (uplink physical channels and/or downlink physical channels) may be defined. The physical channels (uplink physical channels and/or downlink physical channels) may be used for transmitting information that is delivered from a higher layer.

For example, in uplink, a PRACH (Physical Random Access Channel) may be defined. In some approaches, the PRACH (e.g., the random access procedure) may be used for an initial access connection establishment procedure, a handover procedure, a connection re-establishment, a timing adjustment (e.g., a synchronization for an uplink transmission, for UL synchronization) and/or for requesting an uplink shared channel (UL-SCH) resource (e.g., the uplink physical shared channel (PSCH) (e.g., PUSCH) resource).

In another example, a physical uplink control channel (PUCCH) may be defined. The PUCCH may be used for transmitting uplink control information (UCI). The UCI may include hybrid automatic repeat request-acknowledgement (HARQ-ACK), channel state information (CSI) and/or a scheduling request (SR). The HARQ-ACK is used for indicating a positive acknowledgement (ACK) or a negative acknowledgment (NACK) for downlink data (e.g., Transport block(s), Medium Access Control Protocol Data Unit (MAC PDU) and/or Downlink Shared Channel (DL-SCH)). The CSI is used for indicating state of downlink channel (e.g., a downlink signal(s)). Also, the SR is used for requesting resources of uplink data (e.g., Transport block(s), MAC PDU and/or Uplink Shared Channel (UL-SCH)).

Here, the DL-SCH and/or the UL-SCH may be a transport channel that is used in the MAC layer. Also, a transport block(s) (TB(s)) and/or a MAC PDU may be defined as a unit(s) of the transport channel used in the MAC layer. The transport block may be defined as a unit of data delivered from the MAC layer to the physical layer. The MAC layer may deliver the transport block to the physical layer (e.g., the MAC layer delivers the data as the transport block to the physical layer). In the physical layer, the transport block may be mapped to one or more codewords.

In downlink, a physical downlink control channel (PDCCH) may be defined. The PDCCH may be used for transmitting downlink control information (DCI). Here, more than one DCI formats may be defined for DCI transmission on the PDCCH. Namely, fields may be defined in the DCI format(s), and the fields are mapped to the information bits (e.g., DCI bits).

Additionally or alternatively, a physical downlink shared channel (PDSCH) and a physical uplink shared channel (PUSCH) may be defined. For example, in a case that the PDSCH (e.g., the PDSCH resource) is scheduled by using the DCI format(s) for the downlink, the UE 102 may receive the downlink data, on the scheduled PDSCH (e.g., the PDSCH resource). Additionally or alternatively, in a case that the PUSCH (e.g., the PUSCH resource) is scheduled by using the DCI format(s) for the uplink, the UE 102 transmits the uplink data, on the scheduled PUSCH (e.g., the PUSCH resource). For example, the PDSCH may be used to transmit the downlink data (e.g., DL-SCH(s), a downlink transport block(s)). Additionally or alternatively, the PUSCH may be used to transmit the uplink data (e.g., UL-SCH(s), an uplink transport block(s)).

Furthermore, the PDSCH and/or the PUSCH may be used to transmit information of a higher layer (e.g., a radio resource control (RRC)) layer, and/or a MAC layer). For example, the PDSCH (e.g., from the gNB 160 to the UE 102) and/or the PUSCH (e.g., from the UE 102 to the gNB 160) may be used to transmit a RRC message (a RRC signal). Additionally or alternatively, the PDSCH (e.g., from the gNB 160 to the UE 102) and/or the PUSCH (e.g., from the UE 102 to the gNB 160) may be used to transmit a MAC control element (a MAC CE). Here, the RRC message and/or the MAC CE are also referred to as a higher layer signal.

In some approaches, a physical broadcast channel (PBCH) may be defined. For example, the PBCH may be used for broadcasting the MIB (master information block). Here, system information may be divided into the MIB and a number of SIB(s) (system information block(s)). For example, the MIB may be used for carrying include minimum system information. Additionally or alternatively, the SIB(s) may be used for carrying system information messages.

In some approaches, in downlink, synchronization signals (SSs) may be defined. The SS may be used for acquiring time and/or frequency synchronization with a cell. Additionally or alternatively, the SS may be used for detecting a physical layer cell ID of the cell. SSs may include a primary SS and a secondary SS.

An SS/PBCH block may be defined as a set of a primary SS, a secondary SS and a PBCH. Tin the time domain, the SS/PBCH block consists of 4 OFDM symbols, numbered in increasing order from 0 to 3 within the SS/PBCH block, where PSS, SSS, and PBCH with associated demodulation reference signal (DMRS) are mapped to symbols. One or more SS/PBCH block may be mapped within a certain time duration (e.g., 5 msec).

Additionally, the SS/PBCH block can be used for beam measurement, radio resource management (RRM) measurement and radio link control (RLM) measurement. Specifically, the secondary synchronization signal (SSS) can be used for the measurement.

In the radio communication for uplink, UL RS(s) may be used as uplink physical signal(s). Additionally or alternatively, in the radio communication for downlink, DL RS(s) may be used as downlink physical signal(s). The uplink physical signal(s) and/or the downlink physical signal(s) may not be used to transmit information that is provided from the higher layer, but is used by a physical layer.

Here, the downlink physical channel(s) and/or the downlink physical signal(s) described herein may be assumed to be included in a downlink signal (e.g., a DL signal(s)) in some implementations for the sake of simple descriptions. Additionally or alternatively, the uplink physical channel(s) and/or the uplink physical signal(s) described herein may be assumed to be included in an uplink signal (i.e. an UL signal(s)) in some implementations for the sake of simple descriptions.

The UE operations module 124 may provide information 148 to the one or more receivers 120. For example, the UE operations module 124 may inform the receiver(s) 120 when to receive retransmissions.

The UE operations module 124 may provide information 138 to the demodulator 114. For example, the UE operations module 124 may inform the demodulator 114 of a modulation pattern anticipated for transmissions from the gNB 160.

The UE operations module 124 may provide information 136 to the decoder 108. For example, the UE operations module 124 may inform the decoder 108 of an anticipated encoding for transmissions from the gNB 160.

The UE operations module 124 may provide information 142 to the encoder 150. The information 142 may include data to be encoded and/or instructions for encoding. For example, the UE operations module 124 may instruct the encoder 150 to encode transmission data 146 and/or other information 142. The other information 142 may include PDSCH HARQ-ACK information.

The encoder 150 may encode transmission data 146 and/or other information 142 provided by the UE operations module 124. For example, encoding the data 146 and/or other information 142 may involve error detection and/or correction coding, mapping data to space, time and/or frequency resources for transmission, multiplexing, etc. The encoder 150 may provide encoded data 152 to the modulator 154.

The UE operations module 124 may provide information 144 to the modulator 154. For example, the UE operations module 124 may inform the modulator 154 of a modulation type (e.g., constellation mapping) to be used for transmissions to the gNB 160. The modulator 154 may modulate the encoded data 152 to provide one or more modulated signals 156 to the one or more transmitters 158.

The UE operations module 124 may provide information 140 to the one or more transmitters 158. This information 140 may include instructions for the one or more transmitters 158. For example, the UE operations module 124 may instruct the one or more transmitters 158 when to transmit a signal to the gNB 160. For instance, the one or more transmitters 158 may transmit during a UL subframe. The one or more transmitters 158 may upconvert and transmit the modulated signal(s) 156 to one or more gNBs 160.

Each of the one or more gNBs 160 may include one or more transceivers 176, one or more demodulators 172, one or more decoders 166, one or more encoders 109, one or more modulators 113, a data buffer 162 and a gNB operations module 182. For example, one or more reception and/or transmission paths may be implemented in a gNB 160. For convenience, only a single transceiver 176, decoder 166, demodulator 172, encoder 109 and modulator 113 are illustrated in the gNB 160, though multiple parallel elements (e.g., transceivers 176, decoders 166, demodulators 172, encoders 109 and modulators 113) may be implemented.

The transceiver 176 may include one or more receivers 178 and one or more transmitters 117. The one or more receivers 178 may receive signals from the UE 102 using one or more physical antennas 180a-n. For example, the receiver 178 may receive and downconvert signals to produce one or more received signals 174. The one or more received signals 174 may be provided to a demodulator 172. The one or more transmitters 117 may transmit signals to the UE 102 using one or more physical antennas 180a-n. For example, the one or more transmitters 117 may upconvert and transmit one or more modulated signals 115.

The demodulator 172 may demodulate the one or more received signals 174 to produce one or more demodulated signals 170. The one or more demodulated signals 170 may be provided to the decoder 166. The gNB 160 may use the decoder 166 to decode signals. The decoder 166 may produce one or more decoded signals 164, 168. For example, a first gNB-decoded signal 164 may comprise received payload data, which may be stored in a data buffer 162. A second gNB-decoded signal 168 may comprise overhead data and/or control data. For example, the second gNB-decoded signal 168 may provide data (e.g., PDSCH HARQ-ACK information) that may be used by the gNB operations module 182 to perform one or more operations.

In general, the gNB operations module 182 may enable the gNB 160 to communicate with the one or more UEs 102. The gNB operations module 182 may include one or more of a gNB scheduling module 194. The gNB scheduling module 194 may perform scheduling of downlink and/or uplink transmissions as described herein.

The gNB operations module 182 may provide information 188 to the demodulator 172. For example, the gNB operations module 182 may inform the demodulator 172 of a modulation pattern anticipated for transmissions from the UE(s) 102.

The gNB operations module 182 may provide information 186 to the decoder 166. For example, the gNB operations module 182 may inform the decoder 166 of an anticipated encoding for transmissions from the UE(s) 102.

The gNB operations module 182 may provide information 101 to the encoder 109. The information 101 may include data to be encoded and/or instructions for encoding. For example, the gNB operations module 182 may instruct the encoder 109 to encode information 101, including transmission data 105.

The encoder 109 may encode transmission data 105 and/or other information included in the information 101 provided by the gNB operations module 182. For example, encoding the data 105 and/or other information included in the information 101 may involve error detection and/or correction coding, mapping data to spatial, time and/or frequency resources for transmission, multiplexing, etc. The encoder 109 may provide encoded data 111 to the modulator 113. The transmission data 105 may include network data to be relayed to the UE 102.

The gNB operations module 182 may provide information 103 to the modulator 113. This information 103 may include instructions for the modulator 113. For example, the gNB operations module 182 may inform the modulator 113 of a modulation type (e.g., constellation mapping) to be used for transmissions to the UE(s) 102. The modulator 113 may modulate the encoded data 111 to provide one or more modulated signals 115 to the one or more transmitters 117.

The gNB operations module 182 may provide information 192 to the one or more transmitters 117. This information 192 may include instructions for the one or more transmitters 117. For example, the gNB operations module 182 may instruct the one or more transmitters 117 when to (or when not to) transmit a signal to the UE(s) 102. The one or more transmitters 117 may upconvert and transmit the modulated signal(s) 115 to one or more UEs 102.

It should be noted that a DL subframe may be transmitted from the gNB 160 to one or more UEs 102 and that a UL subframe may be transmitted from one or more UEs 102 to the gNB 160. Furthermore, both the gNB 160 and the one or more UEs 102 may transmit data in a standard special subframe.

It should also be noted that one or more of the elements or parts thereof included in the eNB(s) 160 and UE(s) 102 may be implemented in hardware. For example, one or more of these elements or parts thereof may be implemented as a chip, circuitry or hardware components, etc. It should also be noted that one or more of the functions or methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

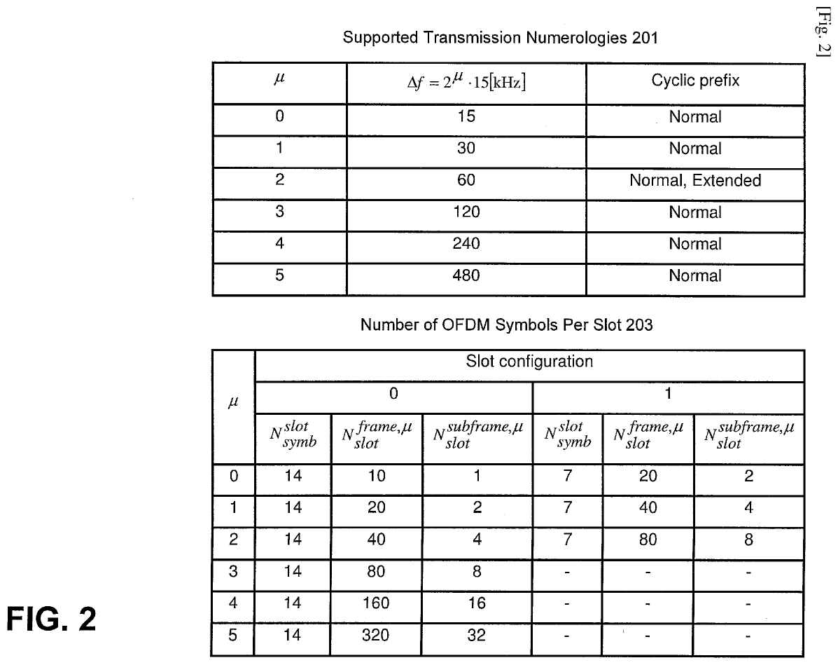

FIG. 2 shows examples of multiple numerologies 201. As shown in FIG. 2, multiple numerologies 201 (e.g., multiple subcarrier spacing) may be supported. For example, μ (e.g., a subcarrier space configuration) and a cyclic prefix (e.g., the μ and the cyclic prefix for a carrier bandwidth part) may be configured by higher layer parameters (e.g., a RRC message) for the downlink and/or the uplink. Here, 15 kHz may be a reference numerology 201. For example, an RE of the reference numerology 201 may be defined with a subcarrier spacing of 15 kHz in a frequency domain and 2048 Ts+CP length (e.g., 160 Ts or 144 Ts) in a time domain, where Ts denotes a baseband sampling time unit defined as 1/(15000*2048) seconds.

Additionally or alternatively, a number of OFDM symbol(s) 203 per slot (N_{symb}^{slot}) may be determined based on the u (e.g., the subcarrier space configuration). Here, for example, a slot configuration 0 (e.g., the number of OFDM symbols 203 per slot may be 14).

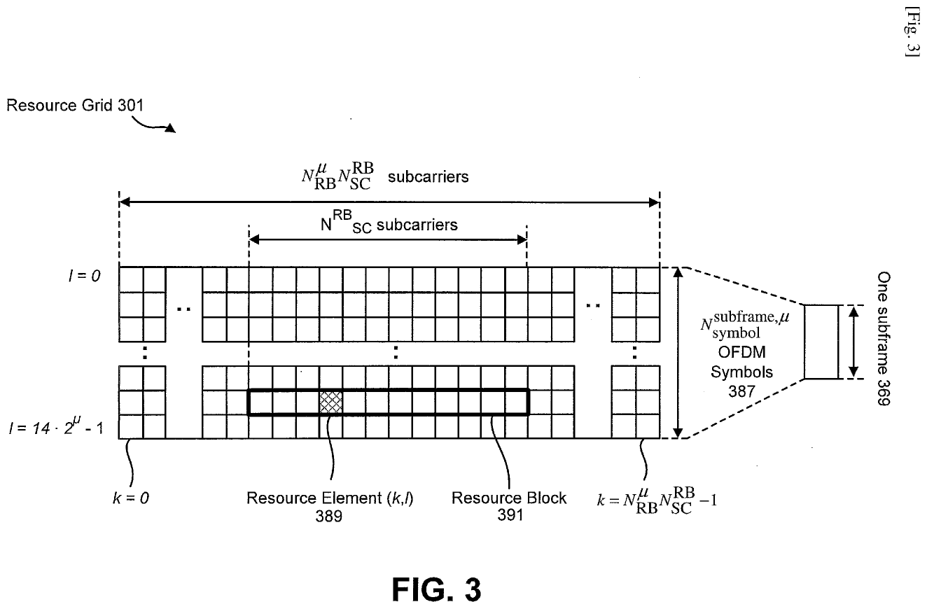

FIG. 3 is a diagram illustrating one example of a resource grid 301 and resource block 391 (e.g., for the downlink and/or the uplink). The resource grid 301 and resource block 391 illustrated in FIG. 3 may be utilized in some implementations of the systems and methods disclosed herein.

In FIG. 3, one subframe 369 may include N_{symbol}^{subframe,μ} symbols 387. Additionally or alternatively, a resource block 391 may include a number of resource elements (RE) 389. Here, in the downlink, the OFDM access scheme with cyclic prefix (CP) may be employed, which may be also referred to as CP-OFDM. A downlink radio frame may include multiple pairs of downlink resource blocks (RBs) 391 which are also referred to as physical resource blocks (PRBs). The downlink RB pair is a unit for assigning downlink radio resources, defined by a predetermined bandwidth (RB bandwidth) and a time slot. The downlink RB pair may include two downlink RBs 391 that are continuous in the time domain. Additionally or alternatively, the downlink RB 391 may include twelve sub-carriers in frequency domain and seven (for normal CP) or six (for extended CP) OFDM symbols in time domain. A region defined by one sub-carrier in frequency domain and one OFDM symbol in time domain is referred to as a resource element (RE) 389 and is uniquely identified by the index pair (k, l), where k and l are indices in the frequency and time domains, respectively.

Additionally or alternatively, in the uplink, in addition to CP-OFDM, a Single-Carrier Frequency Division Multiple Access (SC-FDMA) access scheme may be employed, which is also referred to as Discrete Fourier Transform-Spreading OFDM (DFT-S-OFDM). An uplink radio frame may include multiple pairs of uplink resource blocks 391. The uplink RB pair is a unit for assigning uplink radio resources, defined by a predetermined bandwidth (RB bandwidth) and a time slot. The uplink RB pair may include two uplink RBs 391 that are continuous in the time domain. The uplink RB may include twelve sub-carriers in frequency domain and seven (for normal CP) or six (for extended CP) OFDM/DFT-S-OFDM symbols in time domain. A region defined by one sub-carrier in the frequency domain and one OFDM/DFT-S-OFDM symbol in the time domain is referred to as a resource element (RE) 389 and is uniquely identified by the index pair (k, l) in a slot, where k and I are indices in the frequency and time domains respectively.

Each element in the resource grid 301 (e.g., antenna port p) and the subcarrier configuration u is called a resource element 389 and is uniquely identified by the index pair (k, l) where k=0, . . . , N_{RB}^{μ}N_{SC}^{RB}−1 is the index in the frequency domain and I refers to the symbol position in the time domain. The resource element (k, l) 389 on the antenna port p and the subcarrier spacing configuration u is denoted (k, l) p, μ. The physical resource block 391 is defined as N_{SC}^{RB}=12 consecutive subcarriers in the frequency domain. The physical resource blocks 391 are numbered from 0 to N_{RB}^{μ}−1 in the frequency domain. The relation between the physical resource block number n_{PRB} in the frequency domain and the resource element (k, l) is given by

$${n}_{PRB} = ⌊ \frac{k}{{N}_{SC}^{RB}} ⌋ .$$

In the NR, the following reference signals may be defined:
NZP CSI-RS (non-zero power channel state information reference signal)
ZP CSI-RS (Zero-power channel state information reference signal)
DMRS (demodulation reference signal)
SRS (sounding reference signal)

NZP CSI-RS may be used for channel tracking (e.g., synchronization), measurement to obtain CSI (CSI measurement including channel measurement and interference measurement), and/or measurement to obtain the beam forming performance. NZP CSI-RS may be transmitted in the downlink (gNB to UE). NZP CSI-RS may be transmitted in an aperiodic or semi-persistent or periodic manner. Additionally, the NZP CSI-RS can be used for radio resource management (RRM) measurement and radio link control (RLM) measurement.

ZP CSI-RS may be used for interference measurement and transmitted in the downlink (gNB to UE). ZP CSI-RS may be transmitted in an aperiodic or semi-persistent or periodic manner.

DMRS may be used for demodulation for the downlink (gNB to UE), the uplink (UE to gNB), and the sidelink (UE to UE).

SRS may be used for channel sounding and beam management. The SRS may be transmitted in the uplink (UE to gNB).

In some approaches, the DCI may be used. The following DCI formats may be defined:
DCI format 0_0
DCI format 0_1
DCI format 0_2
DCI format 1_0
DCI format 1_1
DCI format 1_2
DCI format 2_0
DCI format 2_1
DCI format 2_2
DCI format 2_3
DCI format 2_4
DCI format 2_5
DCI format 2_6
DCI format 3_0
DCI format 3_1

DCI format 1_0 may be used for the scheduling of PUSCH in one cell. The DCI may be transmitted by means of the DCI format 0_0 with cyclic redundancy check (CRC) scrambled by Cell Radio Network Temporary Identifiers (C-RNTI) or Configured Scheduling RNTI (CS-RNTI) or Modulation and Coding Scheme-Cell RNTI (MCS-C-RNTI).

DCI format 0_1 may be used for the scheduling of one or multiple PUSCH in one cell, or indicating configured grant downlink feedback information (CG-DFI) to a UE. The DCI may be transmitted by means of the DCI format 0_1 with CRC scrambled by C-RNTI or CS-RNTI or semi-persistent channel state information (SP-CSI-RNTI) or MCS-C-RNTI. The DCI format 0_2 may be used for CSI request (e.g., aperiodic CSI reporting or semi-persistent CSI request). The DCI format 0_2 may be used for SRS request (e.g., aperiodic SRS transmission).

DCI format 0_2 may be used for the scheduling of PUSCH in one cell. The DCI may be transmitted by means of the DCI format 0_2 with CRC scrambled by C-RNTI or CS-RNTI or SP-CSI-RNTI or MCS-C-RNTI. The DCI format 0_2 may be used for scheduling of PUSCH with high priority and/or low latency (e.g., URLLC). The DCI format 0_2 may be used for CSI request (e.g., aperiodic CSI reporting or semi-persistent CSI request). The DCI format 0_2 may be used for SRS request (e.g., aperiodic SRS transmission).

Additionally, for example, the DCI included in the DCI format 0_Y (Y =0, 1, 2, . . . ) may be a BWP indicator (e.g., for the PUSCH). Additionally or alternatively, the DCI included in the DCI format 0_Y may be a frequency domain resource assignment (e.g., for the PUSCH). Additionally or alternatively, the DCI included in the DCI format 0_Y may be a time domain resource assignment (e.g., for the PUSCH). Additionally or alternatively, the DCI included in the DCI format 0_Y may be a modulation and coding scheme (e.g., for the PUSCH). Additionally or alternatively, the DCI included in the DCI format 0_Y may be a new data indicator. Additionally or alternatively, the DCI included in the DCI format 0_Y may be a TPC command for scheduled PUSCH. Additionally or alternatively, the DCI included in the DCI format 0_Y may be a CSI request that is used for requesting the CSI reporting. Additionally or alternatively, as described below, the DCI included in the DCI format 0_Y may be information used for indicating an index of a configuration of a configured grant. Additionally or alternatively, the DCI included in the DCI format 0_Y may be the priority indication (e.g., for the PUSCH transmission and/or for the PUSCH reception).

DCI format 1_0 may be used for the scheduling of PDSCH in one DL cell. The DCI is transmitted by means of the DCI format 1_0 with CRC scrambled by C-RNTI or CS-RNTI or MCS-C-RNTI. The DCI format 1_0 may be used for random access procedure initiated by a PDCCH order. Additionally or alternatively, the DCI may be transmitted by means of the DCI format 1_0 with CRC scrambled by system information RNTI (SI-RNTI), and the DCI may be used for system information transmission and/or reception. Additionally or alternatively, the DCI may be transmitted by means of the DCI format 1_0 with CRC scrambled by random access RNTI (RA-RNTI) for random access response (RAR) (e.g., Msg 2) or msgB-RNTI for 2-step RACH. Additionally or alternatively, the DCI may be transmitted by means of the DCI format 1_0 with CRC scrambled by temporally cell RNTI (TC-RNTI), and the DCI may be used for msg3 transmission by a UE 102.

DCI format 1_1 may be used for the scheduling of PDSCH in one cell. The DCI may be transmitted by means of the DCI format 1_1 with CRC scrambled by C-RNTI or CS-RNTI or MCS-C-RNTI. The DCI format 1_1 may be used for SRS request (e.g., aperiodic SRS transmission).

DCI format 1_2 may be used for the scheduling of PDSCH in one cell. The DCI may be transmitted by means of the DCI format 1_2 with CRC scrambled by C-RNTI or CS-RNTI or SP-CSI-RNTI or MCS-C-RNTI. The DCI format 1_2 may be used for scheduling of PDSCH with high priority and/or low latency (e.g., URLLC). The DCI format 1_2 may be used for SRS request (e.g., aperiodic SRS transmission).

Additionally, for example, the DCI included in the DCI format 1_X may be a BWP indicator (e.g., for the PDSCH). Additionally or alternatively, the DCI included in the DCI format 1_X may be frequency domain resource assignment (e.g., for the PDSCH). Additionally or alternatively, the DCI included in the DCI format 1_X may be a time domain resource assignment (e.g., for the PDSCH). Additionally or alternatively, the DCI included in the DCI format 1_X may be a modulation and coding scheme (e.g., for the PDSCH). Additionally or alternatively, the DCI included in the DCI format 1_X may be a new data indicator. Additionally or alternatively, the DCI included in the DCI format 1_X may be a TPC command for scheduled PUCCH. Additionally or alternatively, the DCI included in the DCI format 1_X may be a CSI request that is used for requesting (e.g., triggering) transmission of the CSI (e.g., CSI reporting (e.g., aperiodic CSI reporting)). Additionally or alternatively, the DCI included in the DCI format 1_X may be a PUCCH resource indicator. Additionally or alternatively, the DCI included in the DCI format 1_X may be a PDSCH-to-HARQ feedback timing indicator. Additionally or alternatively, the DCI included in the DCI format 1_X may be the priority indication (e.g., for the PDSCH transmission and/or the PDSCH reception). Additionally or alternatively, the DCI included in the DCI format 1_X may be the priority indication (e.g., for the HARQ-ACK transmission for the PDSCH and/or the HARQ-ACK reception for the PDSCH).

DCI format 2_0 may be used for notifying the slot format, channel occupancy time (COT) duration for unlicensed band operation, available resource block (RB) set, and search space group switching. The DCI may transmitted by means of the DCI format 2_0 with CRC scrambled by slot format indicator RNTI (SFI-RNTI).

DCI format 2_1 may be used for notifying the physical resource block(s) (PRB(s)) and orthogonal frequency division multiplexing (OFDM) symbol(s) where the UE may assume no transmission is intended for the UE. The DCI is transmitted by means of the DCI format 2_1 with CRC scrambled by interrupted transmission RNTI (INT-RNTI).

DCI format 2_2 may be used for the transmission of transmission power control (TPC) commands for PUCCH and PUSCH. The following information is transmitted by means of the DCI format 2_2 with CRC scrambled by TPC-PUSCH-RNTI or TPC-PUCCH-RNTI. In a case that the CRC is scrambled by TPC-PUSCH-RNTI, the indicated one or more TPC commands may be applied to the TPC loop for PUSCHs. In a case that the CRC is scrambled by TPC-PUCCH-RNTI, the indicated one or more TPC commands may be applied to the TPC loop for PUCCHs.

DCI format 2_3 may be used for the transmission of a group of TPC commands for SRS transmissions by one or more UEs. Along with a TPC command, a SRS request may also be transmitted. The DCI may be is transmitted by means of the DCI format 2_3 with CRC scrambled by TPC-SRS-RNTI.

DCI format 2_4 may be used for notifying the PRB(s) and OFDM symbol(s) where the UE cancels the corresponding UL transmission. The DCI may be transmitted by means of the DCI format 2_4 with CRC scrambled by cancellation indication RNTI (CI-RNTI).

DCI format 2_5 may be used for notifying the availability of soft resources for integrated access and backhaul (IAB) operation. The DCI may be transmitted by means of the DCI format 2_5 with CRC scrambled by availability indication RNTI (AI-RNTI).

DCI format 2_6 may be used for notifying the power saving information outside discontinuous reception (DRX) Active Time for one or more UEs. The DCI may transmitted by means of the DCI format 2_6 with CRC scrambled by power saving RNTI (PS-RNTI).

DCI format 3_0 may be used for scheduling of NR physical sidelink control channel (PSCCH) and NR physical sidelink shared channel (PSSCH) in one cell. The DCI may be transmitted by means of the DCI format 3_0 with CRC scrambled by sidelink RNTI (SL-RNTI) or sidelink configured scheduling RNTI (SL-CS-RNTI). This may be used for vehicular to everything (V2X) operation for NR V2X UE(s).

DCI format 3_1 may be used for scheduling of LTE PSCCH and LTE PSSCH in one cell. The following information is transmitted by means of the DCI format 3_1 with CRC scrambled by SL-L-CS-RNTI. This may be used for LTE V2X operation for LTE V2X UE(s).

The UE 102 may monitor one or more DCI formats on common search space set (CSS) and/or UE-specific search space set (USS). A set of PDCCH candidates for a UE to monitor may be defined in terms of PDCCH search space sets. A search space set can be a CSS set or a USS set. A UE 102 monitors PDCCH candidates in one or more of the following search spaces sets. The search space may be defined by a PDCCH configuration in a RRC layer.
A Type0-PDCCH CSS set may be configured by pdcch-ConfigSIB1 in MIB or by searchSpaceSIB1 in PDCCH-ConfigCommon or by searchSpaceZero in PDCCH-ConfigCommon for a DCI format with CRC scrambled by a SI-RNTI on the primary cell of the MCG,
a Type0A-PDCCH CSS set may be configured by searchSpaceOtherSystemInformation in PDCCH-ConfigCommon for a DCI format with CRC scrambled by a SI-RNTI on the primary cell of the MCG,
a Type1-PDCCH CSS set may be configured by ra-SearchSpace in PDCCH-ConfigCommon for a DCI format with CRC scrambled by a RA-RNTI or a TC-RNTI on the primary cell,
a Type2-PDCCH CSS set may be configured by pagingSearchSpace in PDCCH-ConfigCommon for a DCI format with CRC scrambled by a P-RNTI on the primary cell of the MCG,
a Type3-PDCCH CSS set may be configured by SearchSpace in PDCCH-Config with searchSpaceType=common for DCI formats with CRC scrambled by INT-RNTI, SFI-RNTI, TPC-PUSCH-RNTI, TPC-PUCCH-RNTI, TPC-SRS-RNTI, CI-RNTI, or PS-RNTI and, only for the primary cell, C-RNTI, MCS-C-RNTI, or CS-RNTI(s), and/or.
a USS set may be configured by SearchSpace in PDCCH-Config with searchSpaceType=ue-Specific for DCI formats with CRC scrambled by C-RNTI, MCS-C-RNTI, SP-CSI-RNTI, CS-RNTI(s), SL-RNTI, SL-CS-RNTI, or SL-L-CS-RNTI.

The UE 102 may monitor a set of candidates of the PDCCH in one or more control resource sets (e.g., CORESETs) on the active DL bandwidth part (BWP) on each activated serving cell according to corresponding search space sets. The CORESETs may be configured from gNB 160 to a UE 102, and the CSS set(s) and the USS set(s) are defined in the configured CORESET. One or more CORESET may be configured in a RRC layer.

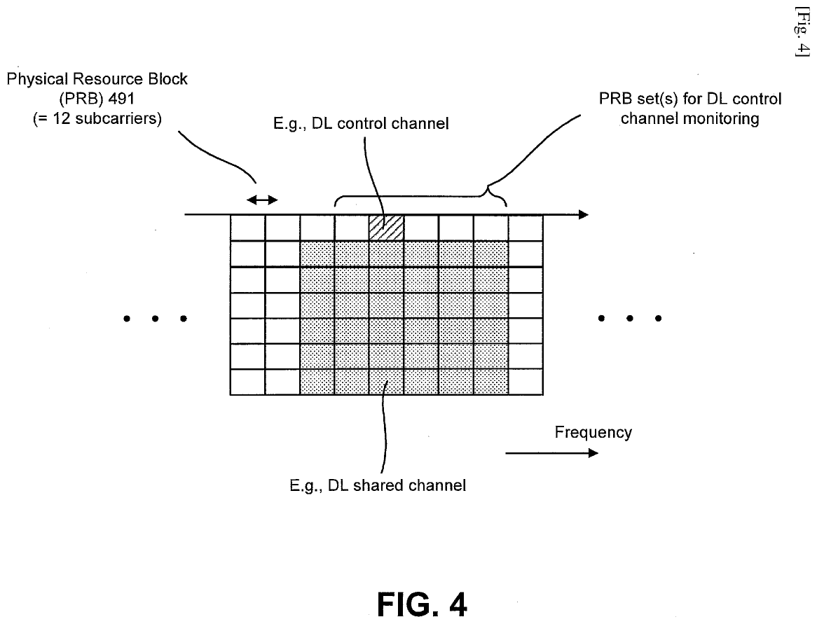

FIG. 4 shows examples of resource regions (e.g., resource region of the downlink). One or more sets 401 of PRB(s) 491 (e.g., a control resource set (e.g., CORESET)) may be configured for DL control channel monitoring (e.g., the PDCCH monitoring). For example, the CORESET is, in the frequency domain and/or the time domain, a set 401 of PRBs 491 within which the UE 102 attempts to decode the DCI (e.g., the DCI format(s), the PDCCH(s)), where the PRBs 491 may or may not be frequency contiguous and/or time contiguous, a UE 102 may be configured with one or more control resource sets (e.g., the CORESETs) and one DCI message may be mapped within one control resource set. In the frequency-domain, a PRB 491 is the resource unit size (which may or may not include DM-RS) for the DL control channel.

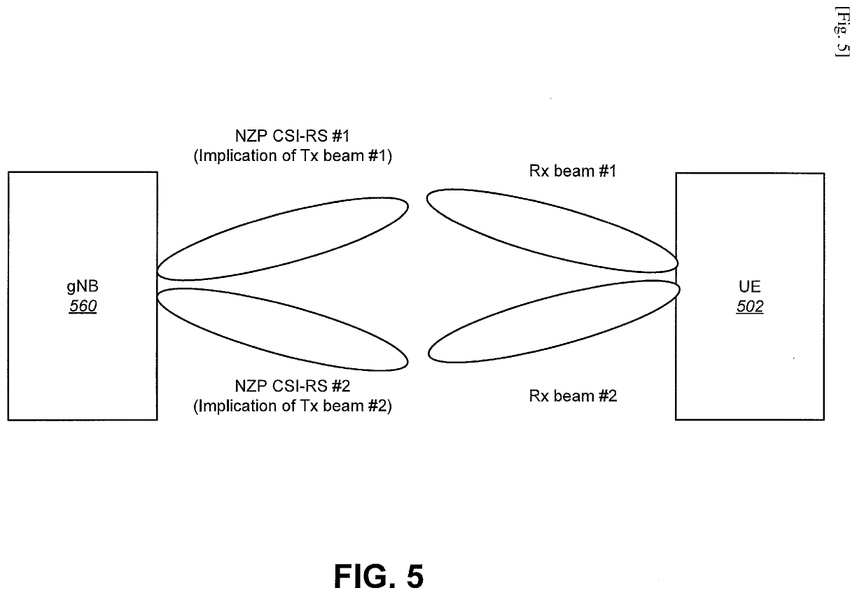

FIG. 5 illustrates an example of beamforming and quasi-colocation (QCL) type. FIG. 5 illustrates a gNB 560 and a UE 502. The gNB 560 may be an example of the gNB 160 described in relation to FIG. 1. The UE 502 may be an example of the UE 102 described in relation to FIG. 1. In NR, the gNB 560 and UE 502 may perform beamforming by having multiple antenna elements. The beamforming is operated by using a directional antenna(s) or applying phase shift for each antenna element, where a high electric field strength to a certain spatial direction can be achieved. Here, beamforming or a beam may be rephrased by “spatial domain transmission filter” or “spatial domain filter.”

In the downlink, the gNB 560 may apply the transmission beamforming and transmit the DL channels and/or DL signals and a UE 502 may also apply the reception beamforming and receive the DL channels and/or DL signals.

In the uplink, a UE 502 may apply the transmission beamforming and transmit the UL channels and/or UL signals and a gNB 560 may also apply the reception beamforming and receive the UL channels and/or UL signals.

The beam correspondence may be defined according to the UE capability. The beam correspondence may be defined in accordance with the following:
In the downlink, a UE 502 can decide the transmission beamforming for UL channels and/or UL signals from the reception beamforming for DL channels and/or DL signals.
In the uplink, a gNB 560 can decide the transmission beamforming for DL channels and/or DL signals from the reception beamforming for UL channels and/or UL signals.

To adaptively switch, refine, or operate beamforming, beam management may be performed. For the beam management, NZP-CSI-RS(s) and SRS(s) may be used to measure the channel quality in the downlink and uplink respectively. Specifically, in the downlink, gNB 560 may transmit one or more NZP CSI-RSs. The UE 502 may measure the one or more NZP CSI-RSs. In addition, the UE 502 may change the beamforming to receive each NZP CSI-RS. The UE 502 can identify which combination of transmission beamforming at gNB side corresponding to NZP CSI-RS corresponding and the reception beamforming at the UE side. In the uplink, a UE 502 may transmit one or more SRSs. The gNB 560 may measure the one or more SRSs. In addition, the gNB 560 may change the reception beamforming to receive each SRS. The gNB 560 can identify which combination of transmission beamforming at gNB side corresponding to SRS corresponding and the reception beamforming at the gNB side.

To keep the link with transmission beam and reception for the communication between a gNB 560 and a UE 502, the quasi-colocation (QCL) assumption may be defined. Two antenna ports are said to be quasi co-located if the large-scale properties of the channel over which a symbol on one antenna port is conveyed can be inferred from the channel over which a symbol on the other antenna port is conveyed. The large-scale properties include one or more of delay spread, Doppler spread, Doppler shift, average gain, average delay, and spatial Rx parameters. The following QCL types may be defined:
QCL type A (‘QCL-TypeA’): {Doppler shift, Doppler spread, average delay, delay spread}
QCL type B (‘QCL-TypeB’): {Doppler shift, Doppler spread}
QCL type C (‘QCL-TypeC’): {Doppler shift, average delay}
QCL type D (‘QCL-TypeD’) {Spatial Rx parameter}

QCL type D is related to the beam management. For example, two NZP CSI-RS resources are configured to a UE 502 and a NZP CSI-RS resource #1 and a NZP CSI-RS resource #2 are used for beam #1 and beam #2, respectively. At a UE side, Rx beam #1 is used for the reception of the NZP CSI-RS #1 and Rx beam #2 is used for reception of the NZP CSI-RS #2 for beam management. Here, the NZP CSI-RS resource #1 and NZP CSI-RS resource #2 imply Tx beam #1 and Tx beam #2 respectively. QCL type D assumption may be used for PDCCH and PDSCH and DL signals reception. When a UE 502 receives a PDCCH with the QCL type D assumption of NZP CSI-RS #1, the UE 502 may use the Rx beam #2 for the PDCCH reception.

For this purpose, a gNB 560 may configure transmission configuration indication (TCI) states to a UE 502. A TCI state may include:
One or more reference resource indices; and/or
QCL type for each of the one or more reference resource indices.

For example, if a TCI state includes QCL type D and NZP CSI-RS #1 indicated to the UE 502, the UE 502 may apply Rx beam #1 to the reception of a PDCCH, a PDSCH, and/or DL signal(s). In other words, a UE 502 can determine the reception beam by using TCI states for reception of PDCCH, PDSCH, and/or DL signals.

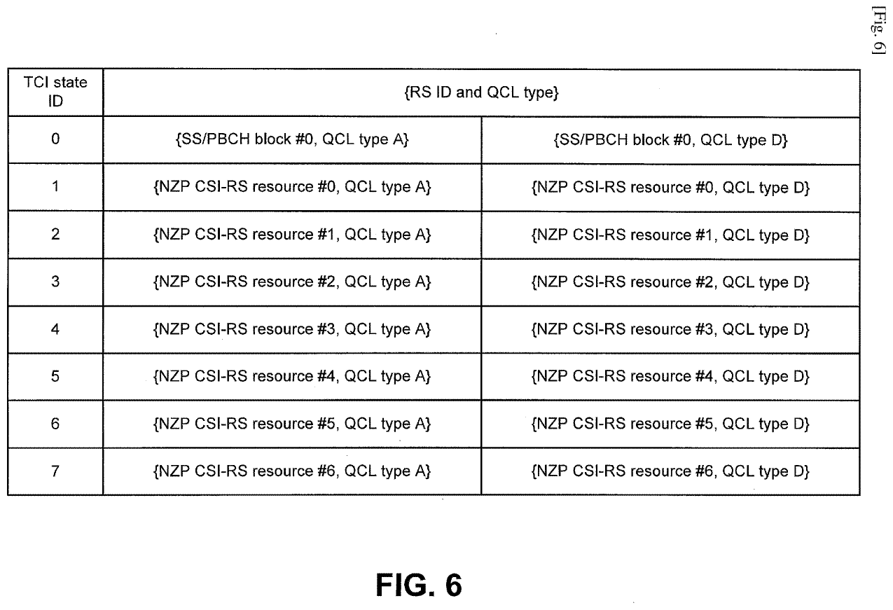

FIG. 6 illustrates an example of TCI states. The seven TCI states may be configured and one of the configured TCI states may be used to receive PDCCH, PDSCH, and/or DL signals. For example, if gNB 560 indicates TCI state #1, a UE 502 may assume the PDCCH, PDSCH, and/or DL signals is (are) quasi-collocated with the NZP CSI-RS corresponding to the NZP CSI-RS resource #1. A UE 502 may determine to use the reception beam when the UE 502 receives the NZP CSI-RS corresponding to the NZP CSI-RS resource #1.

Next, how to indicate one TCI state to a UE 502 from gNB 560. In the RRC messages, N TCI states may be configured by a RRC message. A gNB 560 may indicate one of the configured TCI states by DCI, e.g., DCI format 1_1 or DCI format 1_2. Alternatively or additionally, the gNB 560 may indicate one of the configured TCI by MAC CE. Alternatively or additionally, the MAC CE selects more than one TCI states from the configured TCI states and DCI indicates one of the more than one TCI states activated by MAC CE.

Here, examples of configuration of a common beam of a PDCCH and a PDSCH is explained. As one example, a gNB (e.g., gNB 160 and/or gNB 560) may transmit information to configure a common beam configuration for PDCCH and PDSCH to a UE (e.g., UE 102 and/or UE 502). As used herein, “common beam” may refer to a shared beam or a beam that is shared (e.g., common to multiple channels). The information to configure a common beam for PDCCH and PDSCH may transmitted by RRC signaling. When the gNB (e.g., gNB 160 and/or gNB 560) configures a common beam for PDCCH and PDSCH, the MAC CE may activate one TCI state, and the UE (e.g., UE 102 and/or UE 502) may receive the PDCCH and the PDSCH based on the activated TCI state. For example, the UE (e.g., UE 102 and/or UE 502) may receive the PDCCH and the PDSCH with the same reception beam as the reception of the reference signal included in the activated TCI state. A common beam configuration may enable that the same reception beam is used for reception of one or more PDCCH(s) and/or one or more PDSCH(s). The common beam may be defined as the common TCI or common QCL.

Alternatively or additionally, when a UE (e.g., UE 102 and/or UE 502) is configured with DL carrier aggregation (e.g., more than one DL serving cells are configured), a common beam (e.g., one TCI state) may be applied to the reception of the PDCCHs and/or the PDSCHs for one or more of the configured serving cells. For example, when two DL serving cells (cell #1 and cell #2) and a common beam configuration are configured to the UE (e.g., UE 102 and/or UE 502) and the common beam can be applied to cell #1 and cell #2, the UE may receive a PDCCH on cell #1 and receive a PDCCH on cell #2 based on the activated TCI state by MAC CE or indicated by DCI. For example, the UE may receive a PDCCH on cell #1 and receive a PDCCH on cell #2 by using the same reception beam as the reception of the reference signal(s) included the activated TCI state by MAC CE or indicated by DCI. The TCI state may be indicated by a TCI field in DCI format 1_1 or DCI format 1_2. The reference signal(s) may correspond to QCL type D.

As an example, when the UE (e.g., UE 102 and/or UE 502) receives the information to configure a common beam configuration for two DL serving cells (cell #1 and cell #2), the UE 102 may receive a PDCCH on cell #1 and a PDCCH on cell #2 based on the activated TCI state or indicated TCI state by DCI. For example, the UE may receive a PDSCH on cell #1 and receive a PDSCH on cell #2 by using the same reception beam as the reception of the reference signal(s) included the activated TCI state by MAC CE or indicated by DCI. The TCI state may be indicated by a TCI field in DCI format. The TCI state may be activated by MAC CE.

Alternatively or additionally, when more than one DL serving cell are configured, a serving cell group may be configured to apply a common beam to receive multiple PDCCHs and/or multiple PDSCHs on cells within the serving cell group. More than one DL serving cell may include one primary cell (PCell) or one primary secondary (SPCell) cell and one or more DL secondary cell(s) (SCell(s)). Configuring one or more SCell(s) may be rephrased by configuring more than one serving cells.

Alternatively or additionally, a common beam configuration may be separately configured for each physical channel. For example, a configuration to configure a common beam configuration for PDCCH and a configuration to configure a common beam configuration for PDSCH are configured for a serving cell group. Alternatively or additionally, a common beam configuration may include the combination of one or more downlink channel(s) and a downlink serving cell/downlink serving cell index information to configure a common beam configuration for PDCCH and/or information to configure a common beam configuration for PDSCH may be configured in RRC.

A common beam configuration for PDSCH may be included in the configuration of PDSCH (PDSCH-Config or PDSCH-ConfigCommon). A common beam configuration for PDCCH may be included in the configuration of PDCCH (PDCCH-Config or PDCCH-ConfigCommon).

A set of TCI states for PDSCH may be configured in RRC and a set of TCI states for PDCCH may be configured as a subset of the set of TCI states for PDSCH. For PDCCH TCI state, one from the configured TCI states for PDCCH may be activated by MAC CE. For PDSCH, one or more TCI states from the configured TCI states for PDCCH may be activated by MAC CE. If more than one TCI state are activated, a TCI field in DCI scheduling PDSCH may indicate one TCI state for PDSCH reception. If the TCI field is configured, the UE 102 may receive the PDSCH(s) based on the TCI value of the TCI field in DCI. The UE 102 may receive the same reception beam for PDSCH(s) as the reception for the reference signal included in the indicated TCI state corresponding to the value of the TCI field in the DCI (e.g., DCI format 1_1 or DCI format 1_2).

As another example, a UE (e.g., UE 102 and/or UE 502) may receive information to configure a common beam configuration and information to configure one or more secondary cell(s), and may receive a PDSCH #1 on cell #1 (e.g., PCell) and a PDSCH #2 on cell #2 (e.g., SCell). The information to configure a common beam configuration may indicate whether the same spatial domain filter is utilized for the reception of the PDSCH #1 and PDSCH #2. For example, a gNB (e.g., gNB 160 and/or gNB 560) may transmit information to configure a common beam configuration and information to configure one or more of secondary cell(s), and may transmit a PDSCH #1 on cell #1 (e.g., PCell) and a PDSCH #2 on cell #2 (e.g., SCell). The information to configure a common beam configuration may indicate whether or not the one TCI state is applied to PDSCH #1 and PDSCH #2.

Examples of a common beam configuration for uplink signals or channels is explained (e.g., uplink common TCI). When a common beam configuration is configured, a UE 102 may apply the same transmission beam for both PUSCH and PUCCH. For example, a UE (e.g., UE 102 and/or UE 502) may be configured with the common beam configuration for PUSCH and PUCCH. Additionally or alternatively, when multiple uplink serving cells are configured (e.g., UL CA), the common beam configuration may be applied to PUSCHs and/or PUCCHs for one or more uplink serving cells. For example, when two uplink serving cells (cell #1 and cell #2) are configured and the common beam configuration is configured to the UE (e.g., UE 102 and/or UE 502), the UE may apply the same transmission beam for PUSCHs on cell #1 and cell #2 as the transmission beam for a PUSCH on cell #1.

Additionally or alternatively, a spatial domain filter (e.g., transmission beam) for a PUSCH may be associated with a spatial domain filter for an SRS resource. A UE (e.g., UE 102 and/or UE 502) may be configured with the information on the spatial domain filter by an RRC parameter SRS-SpatialRelationInfo. In the parameter SRS-SpatialRelationInfo, the spatial domain filter for an SRS resource may be associated with an SS/PBCH block, a NZP CSI-RS, and/or an SRS resource configured by the information received in an RRC layer. The parameter SRS-SpatialRelationInfo may include the serving cell index. One or more parameters SRS-SpatialRelationInfo may be included for each SRS resource configuration. The transmission beam (e.g., spatial domain filter) for PUSCH may be determined based on the transmission beam of the configured SRS resource by RRC. A UE (e.g., UE 102 and/or UE 502) may apply the same spatial domain transmission filter for PUSCH as the spatial domain transmission filter of the configured SRS resource. A UE (e.g., UE 102 and/or UE 502) may apply the same spatial domain transmission filter for PUSCH as the spatial domain transmission filter for the activated SRS resource. A UE (e.g., UE 102 and/or UE 502) may apply the same spatial domain transmission filter for PUSCH as the same domain transmission filter for the indicated SRS resource by DCI (e.g., DCI format 0_1 or DCI format 0_2). The SRI field in the DCI may indicate a spatial domain filter of a PUSCH transmission and/or a PUCCH transmission. The DCI scheduling a PDSCH (e.g., DCI format 1_0, 1_1, or 1_2) may be used for determination of the reception of a PDSCH, a PUSCH, and/or a PUCCH. The DCI scheduling a PUSCH (e.g., DCI format 0_0, 0_1, or 0_2) may be used for determination of the reception of a PUSCH, a PDSCH and/or a PUCCH.

A common beam configuration may be separately configured for uplink signals/channels and downlink signals/channels. For example, a common beam configuration for PDCCH/PDSCH and a common beam configuration for PUSCH/PUCCH may be configured.

Examples of a case that a UE 102 has the capability of beam correspondence is explained (e.g., common beam for DL and UL). When a UE (e.g., UE 102 and/or UE 502) has a capability of beam correspondence, the UE may infer or estimate the transmission beam from the reception beam for the downlink channels and/or signals.

As one example, a gNB (gNB 160 and/or gNB 560) may transmit information to configure a common beam configuration (e.g., a UE may receive the information to configure the common beam configuration). When a UE (e.g., UE 102 and/or UE 502) receives the information to configure the common beam configuration, the UE may use the same spatial filter for the transmission of PUSCH(s), PUCCH(s), and/or uplink signal(s) as a spatial filter for the reception of PDCCH(s), PDSCH(s), and/or downlink signal(s). For example, if the common beam configuration is configured to a UE (e.g., UE 102 and/or UE 502), the UE can apply the same spatial filer for the transmission of a PUCCH or a PUSCH as a spatial filter for the reception of a PDCCH.

Additionally or alternatively, a common beam configuration may be separately configured per the combination of channels and signals. For example, a first common beam configuration may indicate the common spatial domain filter for the combination of reception beam for PDCCH on cell #1, reception beam for PDSCH on cell #1 and transmission beam for PUCCH on cell #1. A second common beam configuration may include reception beam for PDSCH on cell #1, PDSCH on cell #2 and transmission beam for PUCCH on cell #1.

Additionally or alternatively, a common beam configuration may be configured to apply a spatial domain filter to all the channels and signals for DL and UL on one or more cell(s).

Additionally or alternatively, each TCI state may include downlink signal(s) (e.g., SS/PBCH block or NZP CSI-RS) or uplink signal(s), e.g., an SRS resource. If a TCI state includes uplink signals, the same spatial domain filter as the spatial domain filter for transmission corresponding to the indicated SRS resource may be used.

As mentioned above, this description includes examples of a UE implementation where the MAC CE or the DCI indicates the TCI state to change the spatial domain filter for downlink channel(s)/signal(s) and/or uplink channel(s)/signal(s).

As another example, a gNB (e.g., gNB 160 and/or gNB 560) may indicate a TCI state including DL TCI and UL spatial relation information (e.g., joint indication of DL and UL beam). For example, each TCI state may include 1) one or more the combination of a downlink reference signal and the corresponding QCL type (A, B, C, or D) for the DL reception beam and/or 2) spatial relation for a PUSCH or a PUCCH. The spatial relation for the PUSCH may be associated with each SRS resource. The spatial relation for PUCCH may be configured by RRC or activated by MAC CE or indicated by DCI.

Additionally or alternatively, RRC information may indicate one or more combinations of DL TCI state(s) and UL spatial relation parameter(s). Each combination may include one or more (M) DL TCI states and one or more (N) UL spatial relation parameter(s). Each DL TCI state may include one or more DL reference signal(s) (e.g., SS/PBCH block index(es) and/or NZP-CSI-RS index(es)) and the corresponding QCL type. Each UL spatial relation parameter may include one or more reference signal(s) (e.g., SS/PBCH block index(es), NZP CSI-RS index(es), and/or SRS resource index(es)). UL spatial relation parameter may be called UL TCI. A MAC CE may activate one DL TCI and one UL TCI.

When a TCI field in the DCI is not configured, the combination of DL TCI and UL TCI corresponding to the TCI state for a PDCCH may be applied for the reception of a PDCCH, a scheduled PDSCH, and the transmission of a PUSCH. The combination of DL TCI(s) and UL TCI(s) may be configured for each CORESET configuration. If the time duration between a PDSCH and the scheduled PDSCH is less than a configured threshold in RRC (timeDurationQCL), the combination of DL TCI(s) and UL TCI(s) may be a combination of DL TCI(s) and UL TCI(s) associated with the monitored search space with the lowest CORESET ID.

A configuration of a joint TCI may indicate one or more combinations, and each combination may include downlink transmission configuration indication (TCI) and uplink transmission configuration indication (TCI). Information of presence of a TCI field in the DCI scheduling may be configured, and information of a time duration threshold (e.g., timeDurationQCL) between the PDCCH and the PDSCH.

If the TCI field is present by the configuration of presence of the TCI field and a time duration between the PDCCH and PDSCH is equal to or greater than the time duration threshold, a UE (e.g., UE 102 and/or UE 502) may transmit a PUSCH or a PUCCH based on the TCI state corresponding to the value of the TCI field in the DCI.

If the TCI field is present by the configuration of the presence of the TCI field and a time duration between the PDCCH and PDSCH is equal to or greater than the time duration threshold, a UE (e.g., UE 102 and/or UE 502) may transmit a PUSCH or a PUCCH based on a combination of a DL TCI and UL TCI corresponding to the value of the TCI field in the DCI.

If the TCI field is not present by the configuration of the presence of the TCI field or absence of the configuration of the presence of the TCI field, and a time duration between the PDCCH and PDSCH is equal to or greater than the time duration threshold, a UE (e.g., UE 102 and/or UE 502) may transmit a PUSCH or a PUCCH based on a combination of a DL TCI and UL TCI corresponding to a control resource set (CORESET) for the PDCCH.

If a time duration between the PDCCH and PDSCH is less than the time duration threshold, a UE (e.g., UE 102 and/or UE 502) may transmit a PUSCH or a PUCCH based on a combination of a DL TCI and UL TCI corresponding to a control resource set (CORESET) with a monitored search space with the lowest index of the CORESET index.

In the above explanation, “DL TCI” may be the information on the reception of a PDSCH, a PDCCH, and/or downlink reference signals. “UL TCI” may be the information on the transmission of a PUSCH, a PUCCH, and/or uplink reference signals.

In the above explanation, “A is configured to a UE” (e.g., UE 102 and/or UE 502) may mean a gNB (e.g., gNB 160 and/or gNB 560) transmits information to configure A in RRC and a UE receives the information to configure A in RRC. “A UE is configured with A” may mean a gNB (e.g., gNB 160 and/or gNB 560) transmits information to configure A in RRC and a UE (e.g., UE 102 and/or UE 502) receives the information to configure A in RRC. In some examples, one or more of the above implementations may also apply a semi-persistent PDSCH or a configured grant for a PUSCH.

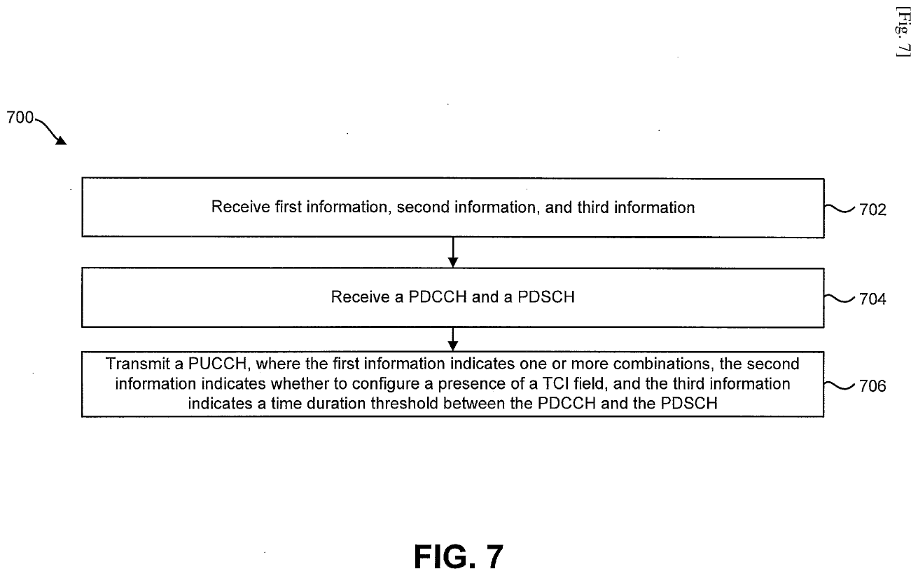

FIG. 7 is a flow diagram illustrating an example of a method 700 for joint beam management. A UE (e.g., UE 102 and/or UE 502) may receive 702 first information, second information, and/or third information. The UE may receive 704 a PDCCH and a PDSCH. The UE may transmit a PUCCH. The first information may indicate one or more combinations. Each combination may include a downlink TCI and an uplink TCI. The second information may indicate whether to configure a presence of a TCI field in DCI carried by the PDCCH. The third information may indicate a time duration threshold between the PDCCH and the PDSCH. The PUCCH may be transmitted based on a first combination corresponding to the TCI field in the DCI in a case that the TCI field in the DCI is present and a time duration between the PDCCH and the PDSCH is equal to or greater than the time duration threshold. The PUCCH may be transmitted based on a second combination corresponding to a CORESET of the PDCCH in a case that the TCI field in the DCI is not present and the time duration between the PDCCH and the PDSCH is equal to or greater than the time duration threshold. The PUCCH may be transmitted based on a third combination corresponding to a CORESET with a monitored search space with a lowest index of a CORESET index in a case that the time duration between the PDCCH and the PDSCH is less than the time duration threshold.

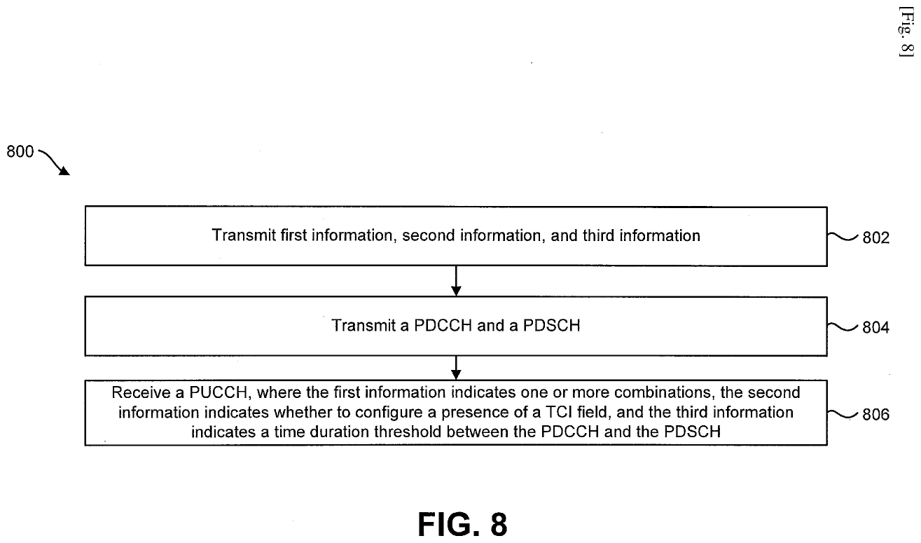

FIG. 8 is a flow diagram illustrating an example of a method 800 for joint beam management. A base station apparatus (e.g., gNB 160 and/or gNB 560) may transmit 802 first information, second information, and/or third information. The base station apparatus may transmit 804 a PDCCH and a PDSCH. The base station may receive 806 a PUCCH. The first information may indicate one or more combinations. Each combination may include a downlink TCI and an uplink TCI. The second information may indicate whether to configure a presence of a TCI field in DCI carried by the PDCCH. The third information may indicate a time duration threshold between the PDCCH and the PDSCH. The PUCCH may be received based on a first combination corresponding to the TCI field in the DCI in a case that the TCI field in the DCI is present and a time duration between the PDCCH and the PDSCH is equal to or greater than the time duration threshold. The PUCCH may be received based on a second combination corresponding to a control resource set (CORESET) of the PDCCH in a case that the TCI field in the DCI is not present and the time duration between the PDCCH and the PDSCH is equal to or greater than the time duration threshold. The PUCCH may be received based on a third combination corresponding to a CORESET with a monitored search space with a lowest index of a CORESET index in a case that the time duration between the PDCCH and the PDSCH is less than the time duration threshold.

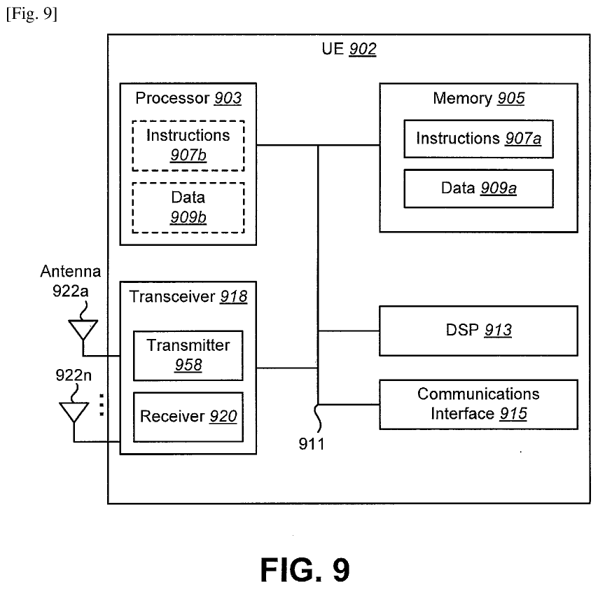

FIG. 9 illustrates various components that may be utilized in a UE 902. The UE 902 described in connection with FIG. 9 may be implemented in accordance with the UE 102 described in connection with FIG. 1 and/or the UE 502 described in connection with FIG. 5. The UE 902 includes a processor 903 that controls operation of the UE 902. The processor 903 may also be referred to as a central processing unit (CPU). Memory 905, which may include read-only memory (ROM), random access memory (RAM), a combination of the two or any type of device that may store information, provides instructions 907a and data 909a to the processor 903. A portion of the memory 905 may also include non-volatile random access memory (NVRAM). Instructions 907b and data 909b may also reside in the processor 903. Instructions 907b and/or data 909b loaded into the processor 903 may also include instructions 907a and/or data 909a from memory 905 that were loaded for execution or processing by the processor 903. The instructions 907b may be executed by the processor 903 to implement one or more of the methods described herein.

The UE 902 may also include a housing that contains one or more transmitters 958 and one or more receivers 920 to allow transmission and reception of data. The transmitter(s) 958 and receiver(s) 920 may be combined into one or more transceivers 918. One or more antennas 922a-n are attached to the housing and electrically coupled to the transceiver 918.

The various components of the UE 902 are coupled together by a bus system 911, which may include a power bus, a control signal bus and a status signal bus, in addition to a data bus. However, for the sake of clarity, the various buses are illustrated in FIG. 9 as the bus system 911. The UE 902 may also include a digital signal processor (DSP) 913 for use in processing signals. The UE 902 may also include a communications interface 915 that provides user access to the functions of the UE 902. The UE 902 illustrated in FIG. 9 is a functional block diagram rather than a listing of specific components.

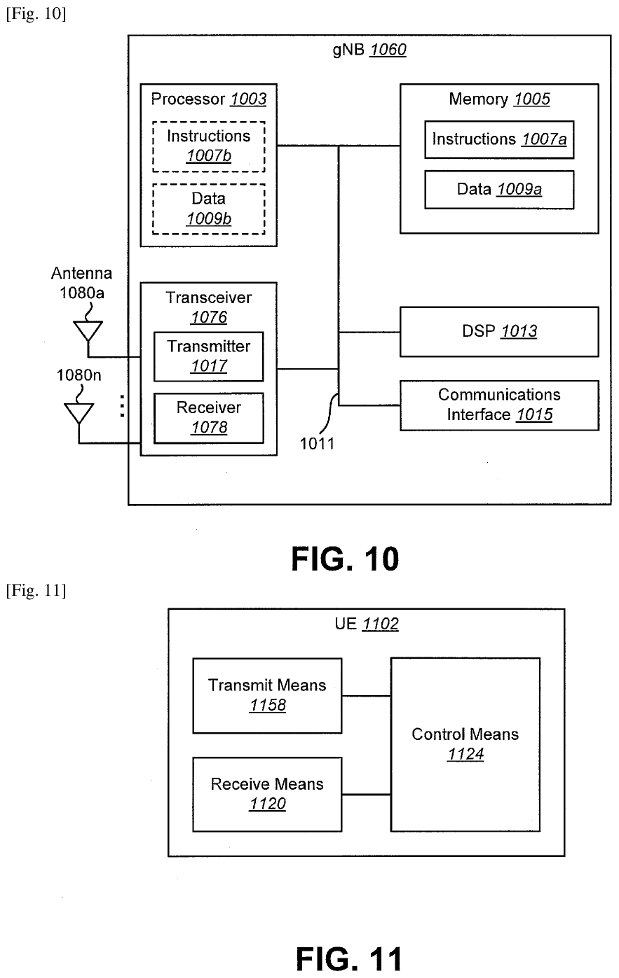

FIG. 10 illustrates various components that may be utilized in a gNB 1060. The gNB 1060 described in connection with FIG. 10 may be implemented in accordance with the gNB 160 described in connection with FIG. 1 and/or the gNB 560 described in connection with FIG. 5. The gNB 1060 includes a processor 1003 that controls operation of the gNB 1060. The processor 1003 may also be referred to as a central processing unit (CPU). Memory 1005, which may include read-only memory (ROM), random access memory (RAM), a combination of the two or any type of device that may store information, provides instructions 1007a and data 1009a to the processor 1003. A portion of the memory 1005 may also include non-volatile random access memory (NVRAM). Instructions 1007b and data 1009b may also reside in the processor 1003. Instructions 1007b and/or data 1009b loaded into the processor 1003 may also include instructions 1007a and/or data 1009a from memory 1005 that were loaded for execution or processing by the processor 1003. The instructions 1007b may be executed by the processor 1003 to implement one or more of the methods described herein.

The gNB 1060 may also include a housing that contains one or more transmitters 1017 and one or more receivers 1078 to allow transmission and reception of data. The transmitter(s) 1017 and receiver(s) 1078 may be combined into one or more transceivers 1076. One or more antennas 1080a-n are attached to the housing and electrically coupled to the transceiver 1076.

The various components of the gNB 1060 are coupled together by a bus system 1011, which may include a power bus, a control signal bus and a status signal bus, in addition to a data bus. However, for the sake of clarity, the various buses are illustrated in FIG. 10 as the bus system 1011. The gNB 1060 may also include a digital signal processor (DSP) 1013 for use in processing signals. The gNB 1060 may also include a communications interface 1015 that provides user access to the functions of the gNB 1060. The gNB 1060 illustrated in FIG. 10 is a functional block diagram rather than a listing of specific components.

FIG. 11 is a block diagram illustrating one implementation of a UE 1102 in which one or more of the systems and/or methods described herein may be implemented. The UE 1102 includes transmit means 1158, receive means 1120 and control means 1124. The transmit means 1158, receive means 1120 and control means 1124 may be configured to perform one or more of the functions described in connection with FIG. 1 above. FIG. 9 above illustrates one example of a concrete apparatus structure of FIG. 11. Other various structures may be implemented to realize one or more of the functions of FIG. 1. For example, a DSP may be realized by software.

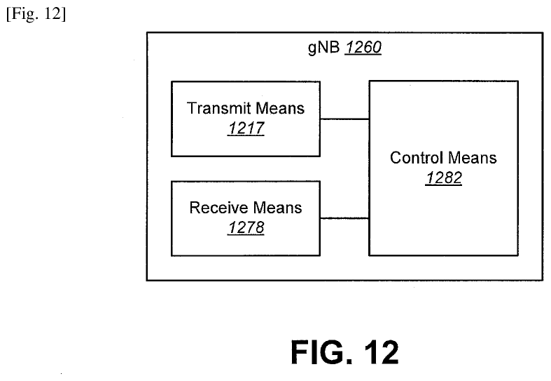

FIG. 12 is a block diagram illustrating one implementation of a gNB 1260 in which one or more of the systems and/or methods described herein may be implemented. The gNB 1260 includes transmit means 1217, receive means 1278 and control means 1282. The transmit means 1217, receive means 1278 and control means 1282 may be configured to perform one or more of the functions described in connection with FIG. 1 above. FIG. 10 above illustrates one example of a concrete apparatus structure of FIG. 12. Other various structures may be implemented to realize one or more of the functions of FIG. 1. For example, a DSP may be realized by software.

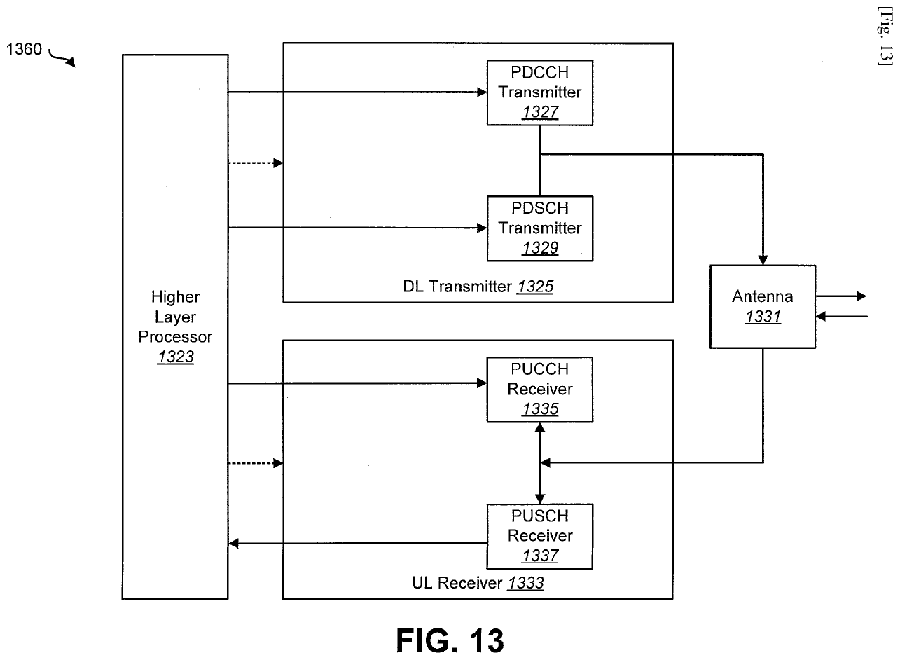

FIG. 13 is a block diagram illustrating one implementation of a gNB 1360. The gNB 1360 may be an example of the gNB 160 described in connection with FIG. 1 and/or of the gNB 560 described in connection with FIG. 5. The gNB 1360 may include a higher layer processor 1323, a DL transmitter 1325, a UL receiver 1333, and one or more antenna 1331. The DL transmitter 1325 may include a PDCCH transmitter 1327 and a PDSCH transmitter 1329. The UL receiver 1333 may include a PUCCH receiver 1335 and a PUSCH receiver 1337.

The higher layer processor 1323 may manage physical layer's behaviors (the DL transmitter's and the UL receiver's behaviors) and provide higher layer parameters to the physical layer. The higher layer processor 1323 may obtain transport blocks from the physical layer. The higher layer processor 1323 may send/acquire higher layer messages such as an RRC message and MAC message to/from a UE's higher layer. The higher layer processor 1323 may provide the PDSCH transmitter transport blocks and provide the PDCCH transmitter transmission parameters related to the transport blocks.

The DL transmitter 1325 may multiplex downlink physical channels and downlink physical signals (including reservation signal) and transmit them via transmission antennas 1331. The UL receiver 1333 may receive multiplexed uplink physical channels and uplink physical signals via receiving antennas 1331 and de-multiplex them. The PUCCH receiver 1335 may provide the higher layer processor 1323 UCI. The PUSCH receiver 1337 may provide the higher layer processor 1323 received transport blocks.

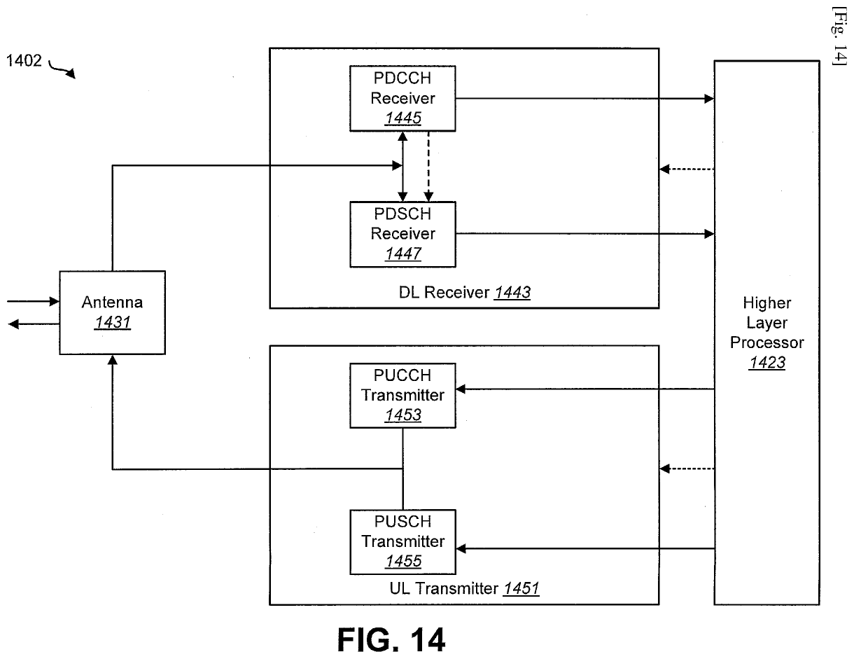

FIG. 14 is a block diagram illustrating one implementation of a UE 1402. The UE 1402 may be an example of the UE 102 described in connection with FIG. 1 and/or of the UE 502 described in connection with FIG. 5. The UE 1402 may include a higher layer processor 1423, a UL transmitter 1451, a DL receiver 1443, and one or more antenna 1431. The UL transmitter 1451 may include a PUCCH transmitter 1453 and a PUSCH transmitter 1455. The DL receiver 1443 may include a PDCCH receiver 1445 and a PDSCH receiver 1447.

The higher layer processor 1423 may manage physical layer's behaviors (the UL transmitter's and the DL receiver's behaviors) and provide higher layer parameters to the physical layer. The higher layer processor 1423 may obtain transport blocks from the physical layer. The higher layer processor 1423 may send/acquire higher layer messages such as an RRC message and MAC message to/from a UE's higher layer. The higher layer processor 1423 may provide the PUSCH transmitter transport blocks and provide the PUCCH transmitter 1453 UCI.

The DL receiver 1443 may receive multiplexed downlink physical channels and downlink physical signals via receiving antennas 1431 and de-multiplex them. The PDCCH receiver 1445 may provide the higher layer processor 1423 DCI. The PDSCH receiver 1447 may provide the higher layer processor 1423 received transport blocks.

L1/L2-centric inter-cell mobility and/or inter-cell mTRP is described herein. In general, L1/L2-centric inter-cell mobility and/or inter-cell mTRP may mean inter-cell mobility (e.g. handover among different cells and/or TRPs) with Layer 1 and/or Layer 2 support. L1/L2-centric inter-cell mobility and/or inter-cell mTRP may include multi-beam measurement/reporting enhancements in non-serving cell(s). L1/L2-centric inter-cell mobility and/or inter-cell mTRP may include L1-based event-driven reporting (e.g., CSI reporting), e.g., definition of L1-based event, beam metric (e.g., L1-RSRP and other metrics). L1/L2-centric inter-cell mobility and/or inter-cell mTRP may include support of one or more RS type(s) as measurement RS, e.g., CSI-RS for mobility/RRM associated with a non-serving cell, CSI-RS for BM associated with a non-serving cell, and/or CSI-RS for tracking associated with a non-serving cell. An RS is associated with a non-serving cell may mean that it is either configured for a non-serving cell or configured for a serving cell but is QCLed with a non-serving cell SSB. L1/L2-centric inter-cell mobility and/or inter-cell mTRP may include beam indication enhancements, e.g., MAC-CE-based and/or DCI-based beam indication (at least using DCI formats 1_1/1_2 with and without DL assignment including the associated MAC-CE-based TCI state activation). The beam indication enhancements may apply to PDSCH/PUSCH associated with UE-dedicated CORESETs only or additional target channels (e.g. UE-dedicated PDCCH/PUCCH). The beam indication enhancements may be supported only for joint TCI, or both joint TCI and separate DL/UL TCI (including that, if separate DL/UL TCI is supported, the DL TCI and UL TCI associated with a same cell). Activation of TCI states for more than one cells simultaneously may or may not be supported and/or whether to support or not may be RRC configurable (indicated by a RRC message). The beam indication may be MAC-CE only based and MAC-CE+DCI-based. L1/L2-centric inter-cell mobility and/or inter-cell mTRP may include a use of SSB associated with a physical cell ID different from that of the serving cell as an indirect QCL reference for UE-dedicated PDSCH. This use may or may not also apply to UE-dedicated PDCCH. When RS X is an indirect QCL reference of a target channel, there exists at least one other source signal on the QCL chain between RS X and the target channel. SSB associated with a physical cell ID different from that of the serving cell may or may not also be used as a direct QCL reference (source RS) for UE-dedicated PDCCH/PDSCH.

Whether to support L1/L2-centric inter-cell mobility and/or inter-cell mTRP or not may be a UE capability. A capability signalling may comprise a parameter which indicates whether the UE supports L1/L2-centric inter-cell mobility and/or inter-cell mTRP. Whether to apply/use/implement L1/L2-centric inter-cell mobility and/or inter-cell mTRP or not may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

Whether to support multi-beam measurement/reporting enhancements in non-serving cell(s) for L1/L2-centric inter-cell mobility and/or inter-cell mTRP or not may be a UE capability. A capability signalling may comprise a parameter which indicates whether the UE supports multi-beam measurement/reporting enhancements in non-serving cell(s), e.g., L1-based event-driven reporting (e.g., CSI reporting), e.g., definition of L1-based event, beam metric (e.g., L1-RSRP and other metrics). Whether to apply/use/implement multi-beam measurement/reporting enhancements in non-serving cell(s) or not may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

Whether to support CSI-RS for mobility/RRM associated with a non-serving cell as measurement RS for L1/L2-centric inter-cell mobility and/or inter-cell mTRP or not may be a UE capability. A capability signalling may comprise a parameter which indicates whether the UE supports CSI-RS (e.g., RS resource configuration(s), CSI reporting configurations) for mobility/RRM associated with a non-serving cell as measurement RS for L1/L2-centric inter-cell mobility and/or inter-cell mTRP. Whether to apply/use/implement CSI-RS for mobility/RRM associated with a non-serving cell as measurement RS for L1/L2-centric inter-cell mobility and/or inter-cell mTRP or not may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec. Configurations of CSI-RS for mobility/RRM associated with a non-serving cell (e.g., cell ID, resource ID, carrier indication/index, BWP indication/index, time domain resource, periodicity, slot/symbol offset, frequency domain resource, RBs, RB index, start of RBs, number of RBs, spatial domain resource, antenna port(s), CDM type, and so on) may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

Whether to support CSI-RS for BM associated with a non-serving cell as measurement RS for L1/L2-centric inter-cell mobility and/or inter-cell mTRP or not may be a UE capability. A capability signalling may comprise a parameter which indicates whether the UE supports CSI-RS (e.g., RS resource configuration(s), CSI reporting configurations) for BM associated with a non-serving cell as measurement RS for L1/L2-centric inter-cell mobility and/or inter-cell mTRP. Whether to apply/use/implement CSI-RS for BM associated with a non-serving cell as measurement RS for L1/L2-centric inter-cell mobility and/or inter-cell mTRP or not may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec. Configurations of CSI-RS for BM associated with a non-serving cell (e.g., cell ID, resource ID, carrier indication/index, BWP indication/index, time domain resource, periodicity, slot/symbol offset, frequency domain resource, RBs, RB index, start of RBs, number of RBs, spatial domain resource, antenna port(s), CDM type, and so on) may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

Whether to support CSI-RS for tracking associated with a non-serving cell as measurement RS for L1/L2-centric inter-cell mobility and/or inter-cell mTRP or not may be a UE capability. A capability signalling may comprise a parameter which indicates whether the UE supports CSI-RS (e.g., RS resource configuration(s), CSI reporting configurations) for tracking associated with a non-serving cell as measurement RS for L1/L2-centric inter-cell mobility and/or inter-cell mTRP. Whether to apply/use/implement CSI-RS for tracking associated with a non-serving cell as measurement RS for L1/L2-centric inter-cell mobility and/or inter-cell mTRP or not may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec. Configurations of CSI-RS for tracking associated with a non-serving cell (e.g., cell ID, resource ID, carrier indication/index, BWP indication/index, time domain resource, periodicity, slot/symbol offset, frequency domain resource, RBs, RB index, start of RBs, number of RBs, spatial domain resource, antenna port(s), CDM type, and so on) may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

Whether to support beam indication enhancements for L1/L2-centric inter-cell mobility and/or inter-cell mTRP or not may be a UE capability. A capability signalling may comprise a parameter which indicates whether the UE supports beam indication enhancements for L1/L2-centric inter-cell mobility and/or inter-cell mTRP, e.g., MAC-CE-based and/or DCI-based beam indication. Whether to apply/use/implement beam indication enhancements for L1/L2-centric inter-cell mobility and/or inter-cell mTRP or not may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

A maximum number of beams associated at least with non-serving cell(s) (e.g., a maximum total number of beams associated with all corresponding non-serving cells) reported in a single CSI reporting instance may be a UE capability. A capability signalling (e.g., csi-ReportFramework, csi-ReportFrameworkExt-mobility) may comprise a parameter (e.g., maxNumberBeams-nonservingcell-ForL1L2Mobility) which indicates the maximum number of beams associated with non-serving cell(s). Whether to apply/use/implement the maximum number of beams associated with non-serving cell(s) for L1/L2-centric inter-cell mobility and/or inter-cell mTRP or not and/or the maximum value of supported beams associated with non-serving cell(s) may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

A maximum number of beams associated at least with a non-serving cell (e.g., a maximum number of beams associated with a non-serving cell (per non-serving cell)) reported in a single CSI reporting instance may be a UE capability. A capability signalling (e.g., csi-ReportFramework, csi-ReportFrameworkExt-mobility) may comprise a parameter (e.g., maxNumberBeams-Pernonservingcell-ForL1L2Mobility) which indicates the maximum number of beams associated with each non-serving cell. Whether to apply/use/implement the maximum number of beams associated with each non-serving cell for L1/L2-centric inter-cell mobility and/or inter-cell mTRP or not and/or the maximum value of supported beams associated with each non-serving cell may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

A maximum number of CSI processing units (CPU) associated with non-serving cell(s) (e.g., a maximum total number of CPUs associated with all corresponding non-serving cells) reported in a single CSI reporting instance may be a UE capability. A capability signalling (e.g., csi-ReportFramework, csi-ReportFrameworkExt-mobility) may comprise a parameter (e.g., simultaneousCSI-Reports-nonservingcell) which indicates the number of CSI report(s) for which the UE can measure and process reference signals simultaneously in all non-serving cell(s) for which this capability is provided. The CSI report comprises periodic, semi-persistent and aperiodic CSI and any latency classes and codebook types. The CSI report in simultaneousCSI-Reports-nonservingcell includes the beam report and CSI report. Whether to apply/use/implement the maximum number of CSI processing units (CPU) associated with non-serving cell(s) for L1/L2-centric inter-cell mobility and/or inter-cell mTRP or not and/or the maximum value of supported CPUs associated with non-serving cell(s) may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

A maximum number of CSI processing units (CPU) associated with a non-serving cell (e.g., a maximum number of CPUs associated with each corresponding non-serving cell (per non-serving cell)) reported in a single CSI reporting instance may be a UE capability. A capability signalling (e.g., csi-ReportFramework, csi-ReportFrameworkExt-mobility) may comprise a parameter (e.g., simultaneousCSI-Reports-Pernonservingcell) which indicates the number of CSI report(s) for which the UE can measure and process reference signals simultaneously in a (each) non-serving cell(s) for which this capability is provided. The CSI report comprises periodic, semi-persistent and aperiodic CSI and any latency classes and codebook types. The CSI report in simultaneousCSI-Reports-Pernonservingcell includes the beam report and CSI report. Whether to apply/use/implement the maximum number of CSI processing units (CPU) associated with a (each) non-serving cell for L1/L2-centric inter-cell mobility and/or inter-cell mTRP or not and/or the maximum value of supported CPUs associated with a (each) non-serving cell(s) may be configured/indicated by a common/dedicated/UE-specific RRC message/signaling and/or SI and/or indicated by L2 signaling (e.g., MAC CE) and/or L1 signaling (e.g., . . . DCI, PDCCH) and/or provided/fixed in spec.

For periodic CSI reporting (report configuration type is configured/chosen as periodic), a (each) CSI reporting setting configuration (e.g., RRC IE CSI-ReportConfig, and/or RRC IE CSI-ReportConfig-nonservingcell configured for non-serving cell(s)) may be corresponding to a CSI resource setting configuration (e.g. IE CSI-ResourceConfig, and/or RRC IE CSI-ResourceConfig-nonservingcell configured for non-serving cell(s)). The CSI resource setting configuration may comprise a NZP CSI-RS Resource Set (e.g. IE NZP-CSI-RS-ResourceSet, and/or RRC IE NZP-CSI-RS-ResourceSet-nonservingcell configured for non-serving cell(s)). The NZP CSI-RS Resource Set may comprise one or more NZP CSI-RS Resource (e.g. IE NZP-CSI-RS-Resource, and/or RRC IE NZP-CSI-RS-Resource-nonservingcell configured for non-serving cell(s)). Each NZP CSI-RS Resource may be corresponding to a beam associated with a serving cell or a non-serving cell. In the NZP CSI-RS Resource Set configuration, the number of NZP CSI-RS Resources corresponding to beam(s) associated with a non-serving cell is not expected to be more than maxNumberBeams-Per-nonservingcell-ForL1L2Mobility if provided/configured as above. Namely, a gNB is not expected to configure a NZP CSI-RS Resource Set configuration with more than maxNumberBeams-Pernonservingcell-ForL1L2Mobility (if provided/configured as above) NZP CSI-RS Resources corresponding to beam(s) associated with a non-serving cell for a UE. In the NZP CSI-RS Resource Set configuration, the number of NZP CSI-RS Resources corresponding to beam(s) associated with all the non-serving cell(s) is not expected to be more than maxNumberBeams-non-servingcell-ForL1L2Mobility if provided/configured as above. Namely, a gNB is not expected to configure a NZP CSI-RS Resource Set configuration with more than maxNumberBeams-nonservingcell-ForL1L2Mobility (if provided/configured as above) NZP CSI-RS Resources corresponding to beam(s) associated with all the non-serving cell(s) for a UE.

For semi-persistent CSI reporting on PUCCH (report configuration type is configured/chosen as semiPersistentOnPUCCH), a (each) CSI reporting setting configuration (e.g., RRC IE CSI-ReportConfig, and/or RRC IE CSI-ReportConfig-nonservingcell configured for non-serving cell(s)) may be corresponding to a CSI resource setting configuration (e.g. IE CSI-ResourceConfig, and/or RRC IE CSI-ResourceConfig-nonservingcell configured for non-serving cell(s)). The CSI resource setting configuration may comprise a NZP CSI-RS Resource Set (e.g. IE NZP-CSI-RS-ResourceSet, and/or RRC IE NZP-CSI-RS-ResourceSet-nonservingcell configured for non-serving cell(s)). The NZP CSI-RS Resource Set may comprise one or more NZP CSI-RS Resource (e.g. IE NZP-CSI-RS-Resource, and/or RRC IE NZP-CSI-RS-Resource-nonservingcell configured for non-serving cell(s)). Each NZP CSI-RS Resource may be corresponding to a beam associated with a serving cell or a non-serving cell. In the NZP CSI-RS Resource Set configuration, the number of NZP CSI-RS Resources corresponding to beam(s) associated with a non-serving cell is not expected to be more than maxNumberBeams-Pernonservingcell-ForL1L2Mobility if provided/configured as above. Namely, a gNB is not expected to configure a NZP CSI-RS Resource Set configuration with more than maxNumberBeams-Pernonservingcell-ForL1L2Mobility (if provided/configured as above) NZP CSI-RS Resources corresponding to beam(s) associated with a non-serving cell for a UE. In the NZP CSI-RS Resource Set configuration, the number of NZP CSI-RS Resources corresponding to beam(s) associated with all the non-serving cell(s) is not expected to be more than maxNumberBeams-nonservingcell-ForL1L2Mobility if provided/configured as above. Namely, a gNB is not expected to configure a NZP CSI-RS Resource Set configuration with more than maxNumberBeams-nonservingcell-ForL1L2Mobility (if provided/configured as above) NZP CSI-RS Resources corresponding to beam(s) associated with all the non-serving cell(s) for a UE.

For semi-persistent CSI reporting on PUSCH (report configuration type is configured/chosen as semiPersistentOnPUSCH), RRC configures a trigger state list (e.g., CSI-SemiPersistentOnPUSCH-TriggerStateList IE) and activation DCI indicates a trigger state (e.g., DCI field CSI Request) from the trigger state. Each trigger state may be corresponding to one or more CSI reporting setting configuration(s) (e.g., RRC IE CSI-ReportConfig, and/or RRC IE CSI-ReportConfig-nonservingcell configured for non-serving cell(s)). Each CSI reporting setting configuration (e.g., RRC IE CSI-ReportConfig, and/or RRC IE CSI-ReportConfig-nonservingcell configured for non-serving cell(s)) may be corresponding to a CSI resource setting configuration (e.g. IE CSI-ResourceConfig, and/or RRC IE CSI-ResourceConfig-nonservingcell configured for non-serving cell(s)). The CSI resource setting configuration may comprise a NZP CSI-RS Resource Set (e.g. IE NZP-CSI-RS-ResourceSet, and/or RRC IE NZP-CSI-RS-ResourceSet-nonservingcell configured for non-serving cell(s)). The NZP CSI-RS Resource Set may comprise one or more NZP CSI-RS Resource (e.g. IE NZP-CSI-RS-Resource, and/or RRC IE NZP-CSI-RS-Resource-nonservingcell configured for non-serving cell(s)). Each NZP CSI-RS Resource may be corresponding to a beam associated with a serving cell or a non-serving cell. In the trigger state list configuration, the number of NZP CSI-RS Resources corresponding to beam(s) associated with a non-serving cell within each trigger state is not expected to be more than maxNumberBeams-Pernonservingcell-ForL1L2Mobility if provided/configured as above. Namely, a gNB is not expected to configure a trigger state where CSI reporting setting configuration(s) (all the NZP CSI-RS Resource Set(s) in all the CSI reporting setting configuration(s) associate with the trigger state) comprise more than maxNumberBeams-Pernonservingcell-ForL1L2Mobility (if provided/configured as above) NZP CSI-RS Resources corresponding to beam(s) associated with a non-serving cell for a UE. In the trigger state list configuration, the number of NZP CSI-RS Resources corresponding to beam(s) associated with a non-serving cell within each trigger state is not expected to be more than maxNumberBeams-nonservingcell-ForL1L2Mobility if provided/configured as above. Namely, a gNB is not expected to configure a trigger state where CSI reporting setting configuration(s) (all the NZP CSI-RS Resource Set(s) in all the CSI reporting setting configuration(s) associate with the trigger state) comprise more than maxNumberBeams-nonservingcell-ForL1L2Mobility (if provided/configured as above) NZP CSI-RS Resources corresponding to beam(s) associated with all the non-serving cell(s) for a UE.

For aperiodic CSI reporting (report configuration type is configured/chosen as aperiodic), RRC configures a trigger state list (e.g., CSI-AperiodicTriggerStateList IE) and DCI indicates a trigger state (e.g., DCI field CSI Request) from the trigger state. Each trigger state may be corresponding to one or more CSI reporting setting configuration(s) (e.g., RRC IE CSI-ReportConfig, and/or RRC IE CSI-ReportConfig-nonservingcell configured for non-serving cell(s)). Each CSI reporting setting configuration (e.g., RRC IE CSI-ReportConfig, and/or RRC IE CSI-ReportConfig-nonservingcell configured for non-serving cell(s)) may be corresponding to a CSI resource setting configuration (e.g. IE CSI-ResourceConfig, and/or RRC IE CSI-ResourceConfig-nonservingcell configured for non-serving cell(s)). The CSI resource setting configuration may comprise one or more NZP CSI-RS Resource Set(s) (e.g. IE NZP-CSI-RS-ResourceSet, and/or RRC IE NZP-CSI-RS-ResourceSet-nonservingcell configured for non-serving cell(s)). Each NZP CSI-RS Resource Set may comprise one or more NZP CSI-RS Resource(s) (e.g. IE NZP-CSI-RS-Resource, and/or RRC IE NZP-CSI-RS-Resource-nonservingcell configured for non-serving cell(s)). Each NZP CSI-RS Resource may be corresponding to a beam associated with a serving cell or a non-serving cell. In the trigger state list configuration, the number of NZP CSI-RS Resources corresponding to beam(s) associated with a non-serving cell within each trigger state is not expected to be more than max NumberBeams-Pernonservingcell-ForL1L2Mobility if provided/configured as above. Namely, a gNB is not expected to configure a trigger state where CSI reporting setting configuration(s) (all the NZP CSI-RS Resource Set(s) in all the CSI reporting setting configuration(s) associate with the trigger state) comprise more than maxNumberBeams-Pernonservingcell-ForL1L2Mobility (if provided/configured as above) NZP CSI-RS Resources corresponding to beam(s) associated with a non-serving cell for a UE. In the trigger state list configuration, the number of NZP CSI-RS Resources corresponding to beam(s) associated with a non-serving cell within each trigger state is not expected to be more than maxNumberBeams-non-servingcell-ForL1L2Mobility if provided/configured as above. Namely, a gNB is not expected to configure a trigger state where CSI reporting setting configuration(s) (all the NZP CSI-RS Resource Set(s) in all the CSI reporting setting configuration(s) associate with the trigger state) comprise more than maxNumberBeams-non-servingcell-ForL1L2Mobility (if provided/configured as above) NZP CSI-RS Resources corresponding to beam(s) associated with all the non-serving cell(s) for a UE.

Beam indication enhancements for L1/L2-centric inter-cell mobility may include TCI state configuration(s), TCI state/list/table configuration(s), MAC-CE-based TCI state activation and/or DCI-based beam indication.

The IE TCI-State associates one or two DL reference signals with a corresponding quasi-colocation (QCL) type. An example of TCI-State information element is shown in Listing 1. ServCellIndex is serving cell index (which may be RRC configured with serving cell configuration (included in a RRC message/signaling for serving cell configuration)). BWP-Id is BWP ID (which may be RRC configured with BWP configuration (included in a RRC message/signaling for BWP configuration)) and indicates the DL BWP which the RS is located in. NZP-CSI-RS-ResourceId is NZP CSI RS Resource ID (which may be RRC configured with NZP CSI RS Resource configuration (included in a RRC message/signaling for NZP CSI RS Resource configuration)). SSB-Index is SSB index (which may be RRC configured with SSB configuration (included in a RRC message/signaling for SSB configuration)).

Listing 1

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

TCI state for beam(s) associated with non-serving cell(s) may be configured in an updated/modified IE TCI-State. Examples of TCI-State information element supporting beam(s) associated with non-serving cell(s) is shown in Listing 2, Listing 3 and Listing 4. A TCI state may be configured with one or two DL reference signals (RS resource configuration(s) and/or RS resource ID(s)) associated with non-serving cell(s) (non-serving cell Index(es)). nonServCellIndex is non-serving cell index (which may be RRC configured with non-serving cell configuration (included in a RRC message/signaling for non-serving cell configuration)). NZP-CSI-RS-nonServCell-ResourceId is NZP CSI RS Resource ID (which may be RRC configured with NZP CSI RS Resource configuration within non-serving cell (included in a RRC message/signaling for NZP CSI RS Resource configuration within non-serving cell)). SSB-nonServCell-Index is SSB index (which may be RRC configured with SSB configuration within non-serving cell (included in a RRC message/signaling for SSB configuration within non-serving cell)).

Listing 2

-- ASN1START
-- TAG-TCI-STATE-START

| | |
|---|---|
| TCI-State ::= | SEQUENCE { |
| tci-StateId | TCI-StateId, |
| qcl-Type1 | QCL-Info, |
| qcl-Type2 | QCL-Info |

OPTIONAL, -- Need R
...
}

| | |
|---|---|
| QCL-Info ::= | SEQUENCE { |
| cell | CHOICE { |

ServCellIndex
nonServCellIndex

| | |
|---|---|
| } | OPTIONAL, -- Need R |
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}
-- TAG-TCI-STATE-STOP
-- ASN1STOP

Listing 3

-- ASN1START
-- TAG-TCI-STATE-START

| | |
|---|---|
| TCI-State ::= | SEQUENCE { |
| tci-StateId | TCI-StateId, |
| qcl-Type1 | QCL-Info-nonServCell, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |

typeD},
...
}

| | |
|---|---|
| QCL-Info-nonServCell ::= | SEQUENCE { |
| cell | nonServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId (or |

NZP-CSI-RS-nonServCell-ResourceId),

| | |
|---|---|
| ssb | SSB-Index (or |

SSB-nonServCell-Index)
},

| | |
|---|---|
| qcl-Type | ENUMERATED {typeA, typeB, typeC, typeD}, |

...
}
-- TAG-TCI-STATE-STOP
-- ASN1STOP

Listing 4

-- ASN1START
-- TAG-TCI-STATE-START

| | |
|---|---|
| TCI-State ::= | SEQUENCE { |
| tci-StateId | TCI-StateId, |
| qcl-Type1 | CHOICE { |

QCL-Info
QCL-Info-nonServCell
},

| | |
|---|---|
| qcl-Type2 | CHOICE { |

QCL-Info
QCL-Info-nonServCell
},
OPTIONAL, -- Need R
...
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, typeD}, |

...
}

| | |
|---|---|
| QCL-Info-nonServCell ::= | SEQUENCE { |
| cell | nonServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId (or |

NZP-CSI-RS-nonServCell-ResourceId),

| | |
|---|---|
| ssb | SSB-Index (or |

SSB-nonServCell-Index)
},

| | |
|---|---|
| qcl-Type | ENUMERATED {typeA, typeB, typeC, typeD}, |

}
-- TAG-TCI-STATE-STOP
-- ASN1STOP

TCI state for beam(s) associated with non-serving cell(s) may be configured in a separate/different IE TCI-State-nonServCell. Examples of TCI-State-nonServCell information element supporting beam(s) associated with non-serving cell(s) is shown in Listing 5 and Listing 6. A TCI state for beam(s) associated with non-serving cell(s) may be configured with one or two DL reference signals (RS resource configuration(s) and/or RS resource ID(s)) associated with non-serving cell(s) (non-serving cell Index(es)). nonServCellIndex is non-serving cell index (which may be RRC configured with non-serving cell configuration (included in a RRC message/signaling for non-serving cell configuration)). NZP-CSI-RS-nonServCell-ResourceId is NZP CSI RS Resource ID (which may be RRC configured with NZP CSI RS Resource configuration within non-serving cell (included in a RRC message/signaling for NZP CSI RS Resource configuration within non-serving cell)). SSB-nonServCell-Index is SSB index (which may be RRC configured with SSB configuration within non-serving cell (included in a RRC message/signaling for SSB configuration within non-serving cell)).

Listing 5

-- ASN1START
-- TAG-TCI-STATE-NONSERVCELL-START

| | |
|---|---|
| TCI-State-nonServCell ::= | SEQUENCE { |
| tci-StateId | TCI-StateId, |
| qcl-Type1 | QCL-Info-nonServCell, |
| qcl-Type2 | QCL-Info |

OPTIONAL, -- Need R
...
}

| | |
|---|---|
| QCL-Info ::= | SEQUENCE { |
| cell | ServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId, |
| ssb | SSB-Index |

},

| | |
|---|---|
| qcl-Type | ENUMERATED {typeA, typeB, typeC, |

typeD},
...
}

| | |
|---|---|
| QCL-Info-nonServCell ::= | SEQUENCE { |
| cell | nonServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId (or |

NZP-CSI-RS-nonServCell-ResourceId),

| | |
|---|---|
| ssb | SSB-Index (or |

SSB-nonServCell-Index)
},

| | |
|---|---|
| qcl-Type | ENUMERATED {typeA, typeB, typeC, typeD}, |

...
}
-- TAG-TCI-STATE-NONSERVCELL-STOP
-- ASN1STOP

Listing 6

-- ASN1START
-- TAG-TCI-STATE-NONSERVCELL-START

| | |
|---|---|
| TCI-State-nonServCell ::= | SEQUENCE { |
| tci-StateId | TCI-StateId, |
| qcl-Type1 | QCL-Info-nonServCell, |
| qcl-Type2 | QCL-Info-nonServCell |

OPTIONAL, -- Need R
...
}

| | |
|---|---|
| QCL-Info-nonServCell ::= | SEQUENCE { |
| cell | nonServCellIndex |

OPTIONAL, -- Need R

| | |
|---|---|
| bwp-Id | BWP-Id |

OPTIONAL, -- Cond CSI-RS-Indicated

| | |
|---|---|
| referenceSignal | CHOICE { |
| csi-rs | NZP-CSI-RS-ResourceId (or |

NZP-CSI-RS-nonServCell-ResourceId),

| | |
|---|---|
| ssb | SSB-Index (or |

SSB-nonServCell-Index)
},

| | |
|---|---|
| qcl-Type | ENUMERATED {typeA, typeB, typeC, typeD}, |

...
}
-- TAG-TCI-STATE-NONSERVCELL-STOP
-- ASN1STOP

RRC signaling/message may provide TCI state/list/table configuration(s). A TCI state/list/table is a list/set of one or more TCI states. An example of TCI state/list/table configuration for PDSCH is shown in Listing 7. The RRC parameter tci-StatesToAddModList is a list of Transmission Configuration Indicator (TCI) states indicating a transmission configuration which includes QCL-relationships between the DL RSs in one RS set and the PDSCH DMRS ports. An example of TCI state/list/table configuration for PDCCH is shown in Listing 8. The RRC parameter tci-StatesPDCCH-ToAddList is a subset of the TCI states defined in pdsch-Config included in the BWP-DownlinkDedicated corresponding to the serving cell and to the DL BWP to which the ControlResourceSet belong to. They are used for providing QCL relationships between the DL RS(s) in one RS Set (TCI-State) and the PDCCH DMRS ports.

Listing 7

-- ASN1START
-- TAG-PDSCH-CONFIG-START

| | |
|---|---|
| PDSCH-Config ::= | SEQUENCE { |
| dataScramblingIdentityPDSCH | INTEGER (0..1023) |

OPTIONAL, -- Need S

| | |
|---|---|
| dmrs-DownlinkForPDSCH-MappingTypeA | SetupRelease { DMRS-DownlinkConfig } |

OPTIONAL, -- Need M

| | |
|---|---|
| dmrs-DownlinkForPDSCH-MappingTypeB | SetupRelease { DMRS-DownlinkConfig } |

OPTIONAL, -- Need M

| | |
|---|---|
| tci-StatesToAddModList | SEQUENCE (SIZE(1..maxNrofTCI-States)) OF TCI-State |

OPTIONAL, -- Need N

| | |
|---|---|
| tci-StatesToReleaseList | SEQUENCE (SIZE(1..maxNrofTCI-States)) OF |

TCI-StateId OPTIONAL, -- Need N

| | |
|---|---|
| vrb-ToPRB-Interleaver | ENUMERATED {n2, n4} |

OPTIONAL, -- Need S

| | |
|---|---|
| resourceAllocation | ENUMERATED { resourceAllocationType0, |

resourceAllocationType1, dynamicSwitch},

| | |
|---|---|
| pdsch-TimeDomainAllocationList | SetupRelease |
| { PDSCH-TimeDomainResourceAllocationList } | OPTIONAL, -- Need M |
| pdsch-AggregationFactor | ENUMERATED { n2, n4, n8 } |

OPTIONAL, -- Need S
...
-- TAG-PDSCH-CONFIG-STOP
-- ASN1STOP

Listing 8

-- ASN1START
-- TAG-CONTROLRESOURCESET-START

| | |
|---|---|
| ControlResourceSet ::= | SEQUENCE { |
| controlResourceSetId | ControlResourceSetId, |
| frequencyDomainResources | BIT STRING (SIZE (45)) , |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6}, |
| shiftIndex | INTEGER (0..maxNrofPhysicalResourceBlocks-1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |
| tci-StatesPDCCH-ToAddList | SEQUENCE(SIZE (1..maxNrofTCI-StatesPDCCH)) OF |

TCI-StateId OPTIONAL, -- Cond NotSIB1-initialBWP

| | |
|---|---|
| tci-StatesPDCCH-ToReleaseList | SEQUENCE(SIZE (1..maxNrofTCI-StatesPDCCH)) OF |

TCI-StateId OPTIONAL, -- Cond NotSIB1-initialBWP

| | |
|---|---|
| tci-PresentInDCI | ENUMERATED {enabled} |

OPTIONAL, -- Need S

| | |
|---|---|
| pdcch-DMRS-ScramblingID | INTEGER (0..65535) |

```
OPTIONAL, -- Need S
  ...,
  [[
```

| | |
|---|---|
| rb-Offset-r16 | INTEGER (0..5) |

OPTIONAL, -- Need S

| | |
|---|---|
| tci-PresentDCI-1-2-r16 | INTEGER (1..3) |

OPTIONAL, -- Need S

| | |
|---|---|
| coresetPoolIndex-r16 | INTEGER (0..1) |

OPTIONAL, -- Need S

| | |
|---|---|
| controlResourceSetId-v1610 | ControlResourceSetId-v1610 |

OPTIONAL -- Need S
]]
}
-- TAG-CONTROLRESOURCESET-STOP
-- ASN1STOP

With the introduction/configuration/presence of TCI state(s) for beam(s) associated with non-serving cell(s), RRC signaling/message may provide TCI state/list/table configuration(s) comprising TCI state(s) for beam(s) associated with non-serving cell(s). A TCI state/list/table may comprise both TCI state(s) for beam(s) associated with non-serving cell(s) and TCI state(s) for beam(s) associated with serving cell(s). For example, the RRC parameter tci-StatesToAddModList is a list of Transmission Configuration Indicator (TCI) states comprising TCI state(s) for beam(s) associated with serving cell(s) (e.g. TCI-State, TCI-StateId) and TCI state(s) for beam(s) associated with non-serving cell(s) (e.g. TCI-State, TCI-State-nonServCell, TCI-StateId). The RRC parameter tci-StatesPDCCH-ToAddList is a list of Transmission Configuration Indicator (TCI) states comprising TCI state(s) for beam(s) associated with serving cell(s) (e.g. TCI-State, TCI-StateId) and TCI state(s) for beam(s) associated with non-serving cell(s) (e.g. TCI-State, TCI-State-nonServCell, TCI-StateId).

With the introduction/configuration/presence of TCI state(s) for beam(s) associated with non-serving cell(s), RRC signaling/message may provide a separate/different TCI state/list/table configuration(s) comprising TCI state(s) for beam(s) associated with non-serving cell(s). Namely, TCI state(s) for beam(s) associated with non-serving cell(s) and TCI state(s) for beam(s) associated with serving cell(s) may be configured in different TCI states/lists/tables. A first TCI state/list/table may comprise TCI state(s) for beam(s) associated with non-serving cell(s) and a second TCI state/list/table may comprise TCI state(s) for beam(s) associated with serving cell(s). For example, the RRC parameter tci-StatesToAddModList is a list of Transmission Configuration Indicator (TCI) states comprising TCI state(s) for beam(s) associated with serving cell(s) (e.g. TCI-State, TCI-StateId) and the RRC parameter tci-StatesToAddModList-nonServCell is a list of Transmission Configuration Indicator (TCI) states comprising TCI state(s) for beam(s) associated with non-serving cell(s) (e.g. TCI-State, TCI-State-nonServCell, TCI-StateId). The RRC parameter tci-StatesPDCCH-ToAddList is a list of Transmission Configuration Indicator (TCI) states comprising TCI state(s) for beam(s) associated with serving cell(s) (e.g. TCI-State, TCI-StateId) and the RRC parameter tci-StatesPDCCH-ToAddList-nonServCell is a list of Transmission Configuration Indicator (TCI) states comprising TCI state(s) for beam(s) associated with non-serving cell(s) (e.g. TCI-State, TCI-State-nonServCell, TCI-StateId). An example of TCI state/list/table configuration for PDSCH supporting beam(s) associated with non-serving cell(s) is shown in Listing 9. An example of TCI state/list/table configuration for PDCCH supporting beam(s) associated with non-serving cell(s) is shown in Listing 10. The RRC parameter tci-StatesToAddModList and the RRC parameter tci-StatesToAddModList-nonServCell may be configured in a same PDSCH configuration (RRC message/signaling, IE). The RRC parameter tci-StatesToAddModList and the RRC parameter tci-StatesToAddModList-nonServCell may be configured in separate/different PDSCH configurations (RRC messages/signalings, IEs). The RRC parameter tci-StatesPDCCH-ToAddList and the RRC parameter tci-StatesPDCCH-ToAddList-nonServCell may be configured in a same PDCCH/CORESET configuration (RRC message/signaling, IE). The RRC parameter tci-StatesPDCCH-ToAddList and the RRC parameter tci-StatesPDCCH-ToAddList-nonServCell may be configured in separate/different PDCCH/CORESET configurations (RRC messages/signalings, IEs).

Listing 9

-- ASN1START
-- TAG-PDSCH-CONFIG-START

| | |
|---|---|
| PDSCH-Config ::= | SEQUENCE { |
| dataScramblingIdentityPDSCH | INTEGER (0..1023) |

OPTIONAL, -- Need S

| | |
|---|---|
| dmrs-DownlinkForPDSCH-MappingTypeA | SetupRelease { DMRS-DownlinkConfig } |

OPTIONAL, -- Need M

| | |
|---|---|
| dmrs-DownlinkForPDSCH-MappingTypeB | SetupRelease { DMRS-DownlinkConfig } |

OPTIONAL, -- Need M

| | |
|---|---|
| tci-StatesToAddModList | SEQUENCE (SIZE(1..maxNrofTCI-States)) OF TCI-State |

OPTIONAL, -- Need N

| | |
|---|---|
| tci-StatesToReleaseList | SEQUENCE (SIZE(1..maxNrofTCI-States)) OF |

| | |
|---|---|
| TCI-StateId | OPTIONAL, -- Need N |

| | |
|---|---|
| tci-StatesToAddModList-nonServCell | SEQUENCE (SIZE(1..maxNrofTCI-States)) |

| | |
|---|---|
| OF TCI-State | OPTIONAL, -- Need N |

| | |
|---|---|
| tci-StatesToReleaseList-nonServCell | SEQUENCE (SIZE(1..maxNrofTCI-States)) |

| | |
|---|---|
| OF TCI-StateId | OPTIONAL, -- Need N |

| | |
|---|---|
| vrb-ToPRB-Interleaver | ENUMERATED {n2, n4} |

OPTIONAL, -- Need S

| | |
|---|---|
| resourceAllocation | ENUMERATED { resourceAllocationType0, |

resourceAllocationType1, dynamicSwitch},

| | |
|---|---|
| pdsch-TimeDomainAllocationList | SetupRelease |
| { PDSCH-TimeDomainResourceAllocationList } | OPTIONAL, -- Need M |
| pdsch-AggregationFactor | ENUMERATED { n2, n4, n8 } |

OPTIONAL, -- Need S
...
-- TAG-PDSCH-CONFIG-STOP
-- ASN1STOP

Listing 10

-- ASN1START
-- TAG-CONTROLRESOURCESET-START

| | |
|---|---|
| ControlResourceSet ::= | SEQUENCE { |
| controlResourceSetId | ControlResourceSetId, |
| frequencyDomainResources | BIT STRING (SIZE (45)), |
| duration | INTEGER (1..maxCoReSetDuration), |
| cce-REG-MappingType | CHOICE { |
| interleaved | SEQUENCE { |
| reg-BundleSize | ENUMERATED {n2, n3, n6}, |
| interleaverSize | ENUMERATED {n2, n3, n6), |
| shiftIndex | INTEGER (0..maxNrofPhysicalResourceBlocks-1) |

OPTIONAL -- Need S
},

| | |
|---|---|
| nonInterleaved | NULL |

},

| | |
|---|---|
| precoderGranularity | ENUMERATED {sameAsREG-bundle, allContiguousRBs}, |

```
  tci-StatesPDCCH-ToAddList-nonServCell SEQUENCE(SIZE
(1..maxNrofTCI-StatesPDCCH)) OF TCI-StateId OPTIONAL, -- Cond NotSIB1-initialBWP
  tci-StatesPDCCH-ToReleaseList-nonServCell SEQUENCE(SIZE
(1..maxNrofTCI-StatesPDCCH) ) OF TCI-StateId OPTIONAL, -- Cond NotSIB1-initialBWP
```

| | |
|---|---|
| tci-PresentInDCI | ENUMERATED {enabled} |

OPTIONAL, -- Need S

| | |
|---|---|
| pdcch-DMRS-ScramblingID | INTEGER (0..65535) |

```
OPTIONAL, -- Need S
  ...,
  [[
```

| | |
|---|---|
| rb-Offset-r16 | INTEGER (0..5) |

OPTIONAL, -- Need S

| | |
|---|---|
| tci-PresentDCI-1-2-r16 | INTEGER (1..3) |

OPTIONAL, -- Need S

| | |
|---|---|
| coresetPoolIndex-r16 | INTEGER (0..1) |

OPTIONAL, -- Need S

| | |
|---|---|
| controlResourceSetId-v1610 | ControlResourceSetId-v1610 |

OPTIONAL -- Need S
]]
}
-- TAG-CONTROLRESOURCESET-STOP
-- ASN1STOP

The network may activate and deactivate the configured TCI states for PDSCH of a Serving Cell or a set of Serving Cells by sending the TCI States Activation/Deactivation for UE-specific PDSCH MAC CE. The network may activate and deactivate the configured TCI states for a codepoint of the DCI Transmission configuration indication field for PDSCH of a Serving Cell by sending the Enhanced TCI States Activation/Deactivation for UE-specific PDSCH MAC CE described. The configured TCI states for PDSCH are initially deactivated upon configuration and after a handover. The MAC entity shall indicate to lower layers the information regarding the TCI States Activation/Deactivation for UE-specific PDSCH MAC CE, if the MAC entity receives a TCI States Activation/Deactivation for UE-specific PDSCH MAC CE on a Serving Cell. The MAC entity shall indicate to lower layers the information regarding the Enhanced TCI States Activation/Deactivation for UE-specific PDSCH MAC CE, if the MAC entity receives an Enhanced TCI States Activation/Deactivation for UE-specific PDSCH MAC CE on a Serving Cell.

With the introduction/configuration/presence of TCI state(s) for beam(s) associated with non-serving cell(s), network may activate and deactivate the configured TCI states for PDSCH of both Serving Cell(s) and non-serving cells by sending the TCI States Activation/Deactivation for UE-specific PDSCH MAC CE. In case that TCI state(s) for beam(s) associated with non-serving cell(s) and TCI state(s) for beam(s) associated with serving cell(s) are configured in TCI state/list/table, network may activate and deactivate the configured TCI states for PDSCH of both Serving Cell(s) and non-serving cells by sending a joint/single TCI States Activation/Deactivation for UE-specific PDSCH MAC CE. In case that TCI state(s) for beam(s) associated with non-serving cell(s) and TCI state(s) for beam(s) associated with serving cell(s) are configured in separate/different TCI states/lists/tables, network may activate and deactivate the configured TCI states for PDSCH of Serving Cell(s) and the configured TCI states for PDSCH of non-serving cells by sending separate TCI States Activations/Deactivations for UE-specific PDSCH MAC CE. The network may support activation of TCI states for more than one cells (serving cell(s) and/or non-serving cell(s)) simultaneously. network may activate and deactivate either the configured TCI states for PDSCH of Serving Cell(s) or the configured TCI states for PDSCH of non-serving cells by sending separate TCI States Activations/Deactivations for UE-specific PDSCH MAC CE. The MAC entity shall indicate to lower layers the information regarding the TCI States Activation/Deactivation for UE-specific PDSCH MAC CE, if the MAC entity receives a TCI States Activation/Deactivation for UE-specific PDSCH MAC CE on a Serving Cell and/or a non-serving cell. The MAC entity shall indicate to lower layers the information regarding the Enhanced TCI States Activation/Deactivation for UE-specific PDSCH MAC CE, if the MAC entity receives an Enhanced TCI States Activation/Deactivation for UE-specific PDSCH MAC CE on a Serving Cell and/or a non-serving cell.

The network may indicate a TCI state for PDCCH reception for a CORESET of a Serving Cell or a set of Serving Cells by sending the TCI State Indication for UE-specific PDCCH MAC CE. The MAC entity shall indicate to lower layers the information regarding the TCI State Indication for UE-specific PDCCH MAC CE, if the MAC entity receives a TCI State Indication for UE-specific PDCCH MAC CE on a Serving Cell.

With the introduction/configuration/presence of TCI state(s) for beam(s) associated with non-serving cell(s), network may indicate a TCI state for PDCCH reception for a CORESET of both Serving Cell(s) and non-serving cells by sending the TCI State Indication for UE-specific PDCCH MAC CE. In case that TCI state(s) for beam(s) associated with non-serving cell(s) and TCI state(s) for beam(s) associated with serving cell(s) are configured in TCI state/list/table, network may activate and deactivate the configured TCI states for PDCCH of both Serving Cell(s) and non-serving cells by sending a joint/single TCI States Activation/Deactivation for UE-specific PDCCH MAC CE. In case that TCI state(s) for beam(s) associated with non-serving cell(s) and TCI state(s) for beam(s) associated with serving cell(s) are configured in separate/different TCI states/lists/tables, network may activate and deactivate the configured TCI states for PDCCH of Serving Cell(s) and the configured TCI states for PDCCH of non-serving cells by sending separate TCI States Activations/Deactivations for UE-specific PDCCH MAC CE. The network may support activation of TCI states for more than one cells (serving cell(s) and/or non-serving cell(s)) simultaneously. network may activate and deactivate either the configured TCI states for PDCCH of Serving Cell(s) or the configured TCI states for PDCCH of non-serving cells by sending separate TCI States Activations/Deactivations for UE-specific PDCCH MAC CE. The MAC entity shall indicate to lower layers the information regarding the TCI State Indication for UE-specific PDCCH MAC CE, if the MAC entity receives a TCI State Indication for UE-specific PDCCH MAC CE on a Serving Cell and/or a non-serving cell.

With the introduction/configuration/presence of TCI state(s) for beam(s) associated with non-serving cell(s), network may indicate a TCI state for PDSCH reception of both Serving Cell(s) and non-serving cells by sending the TCI State Indication for UE-specific PDSCH MAC CE. In case that TCI state(s) for beam(s) associated with non-serving cell(s) and TCI state(s) for beam(s) associated with serving cell(s) are configured in TCI state/list/table, network may activate and deactivate the configured TCI states for PDSCH of both Serving Cell(s) and non-serving cells by sending a joint/single TCI States Activation/Deactivation for UE-specific PDSCH MAC CE. In case that TCI state(s) for beam(s) associated with non-serving cell(s) and TCI state(s) for beam(s) associated with serving cell(s) are configured in separate/different TCI states/lists/tables, network may activate and deactivate the configured TCI states for PDSCH of Serving Cell(s) and the configured TCI states for PDSCH of non-serving cells by sending separate TCI States Activations/Deactivations for UE-specific PDSCH MAC CE. The network may support activation of TCI states for more than one cells (serving cell(s) and/or non-serving cell(s)) simultaneously. network may activate and deactivate either the configured TCI states for PDSCH of Serving Cell(s) or the configured TCI states for PDSCH of non-serving cells by sending separate TCI States Activations/Deactivations for UE-specific PDCCH MAC CE. The MAC entity shall indicate to lower layers the information regarding the TCI State Indication for UE-specific PDSCH MAC CE, if the MAC entity receives a TCI State Indication for UE-specific PDSCH MAC CE on a Serving Cell and/or a non-serving cell.

DCI-based beam indication may be supported. DCI field Transmission configuration indication is used to indicate one of the TCI states which are activated by MAC CE as mentioned above. The set of activated TCI states may comprise both TCI state(s) for beam(s) associated with non-serving cell(s) and TCI state(s) for beam(s) associated with serving cell(s).

In case that activated TCI state(s) for beam(s) associated with non-serving cell(s) and activated TCI state(s) for beam(s) associated with serving cell(s) are comprised in different sets for DCI-based beam indication. How to differentiate DCI-based beam indication from activated TCI state(s) for beam(s) associated with non-serving cell(s) and DCI-based beam indication from activated TCI state(s) for beam(s) associated with serving cell(s) are described herein. There may be two TCI lists/tables as mentioned above. A first TCI lists/tables is a list of Transmission Configuration Indicator (TCI) states comprising TCI state(s) for beam(s) associated with non-serving cell(s) and a second TCI lists/tables is a list of Transmission Configuration Indicator (TCI) states comprising TCI state(s) for beam(s) associated with serving cell(s). A first set of activated TCI states (the set of activated TCI states for beam(s) associated with non-serving cell(s)) may be activated from the first TCI lists/tables by MAC CE and a second set of activated TCI states (the set of activated TCI states for beam(s) associated with serving cell(s)) may be activated from the second TCI list/table by MAC CE.

Whether the first set of activated TCI states or the second set of activated TCI states is used for DCI-based beam indication may depend on radio network temporary identifier (RNTI). For example, if UE detect a PDCCH carrying a DCI format with CRC scrambled by a first RNTI, the DCI field Transmission configuration indication in the DCI format is used to indicate one TCI state from the first set of activated TCI states. If UE detect a PDCCH carrying a DCI format with CRC scrambled by a second RNTI, the DCI field Transmission configuration indication in the DCI format is used to indicate one TCI state from the second set of activated TCI states.

Whether the first set of activated TCI states or the second set of activated TCI states is used for DCI-based beam indication may depend on DCI format. For example, if UE detect a PDCCH carrying a first DCI format, the DCI field Transmission configuration indication in the first DCI format is used to indicate one TCI state from the first set of activated TCI states. If UE detect a PDCCH carrying a second DCI format, the DCI field Transmission configuration indication in the second DCI format is used to indicate one TCI state from the second set of activated TCI states.

Whether the first set of activated TCI states or the second set of activated TCI states is used for DCI-based beam indication may depend on CORESET. For example, if UE detect a PDCCH carrying a DCI format in a first CORESET, the DCI field Transmission configuration indication in the DCI format is used to indicate one TCI state from the first set of activated TCI states. If UE detect a PDCCH carrying a DCI format in a second CORESET, the DCI field Transmission configuration indication in the DCI format is used to indicate one TCI state from the second set of activated TCI states.

Whether the first set of activated TCI states or the second set of activated TCI states is used for DCI-based beam indication may depend on search space. For example, if UE detect a PDCCH carrying a DCI format in a first search space, the DCI field Transmission configuration indication in the DCI format is used to indicate one TCI state from the first set of activated TCI states. If UE detect a PDCCH carrying a DCI format in a second search space, the DCI field Transmission configuration indication in the DCI format is used to indicate one TCI state from the second set of activated TCI states.

Whether the first set of activated TCI states or the second set of activated TCI states is used for DCI-based beam indication may depend on a DCI field(s). The DCI field(s) may be newly introduced or reused from an existing DCI field(s). For example, if UE detect a PDCCH carrying a DCI format and the DCI field set as a first value, the DCI field Transmission configuration indication in the DCI format is used to indicate one TCI state from the first set of activated TCI states. If UE detect a PDCCH carrying a DCI format and the DCI field set as a second value, the DCI field Transmission configuration indication in the DCI format is used to indicate one TCI state from the second set of activated TCI states.

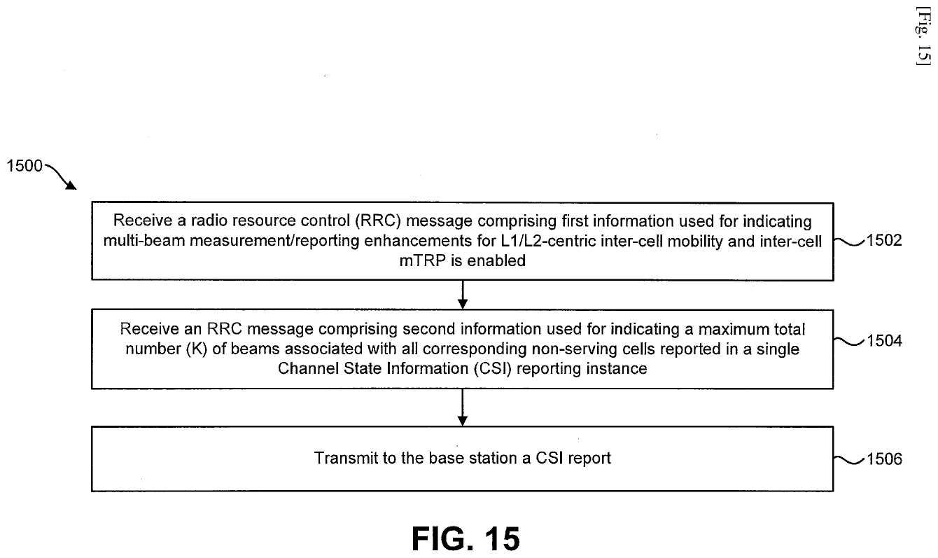

FIG. 15 is a flow diagram illustrating an example of a method 1500 of a UE for beam management with inter-cell mobility. The UE may receive 1502 a radio resource control (RRC) message comprising first information used for indicating multi-beam measurement/reporting enhancements for L1/L2-centric inter-cell mobility and inter-cell mTRP is enabled. The UE may receive 1504 an RRC message comprising second information used for indicating a maximum total number (K) of beams associated with all corresponding non-serving cells reported in a single Channel State Information (CSI) reporting instance. The UE may transmit 1506, to the base station, a CSI report.

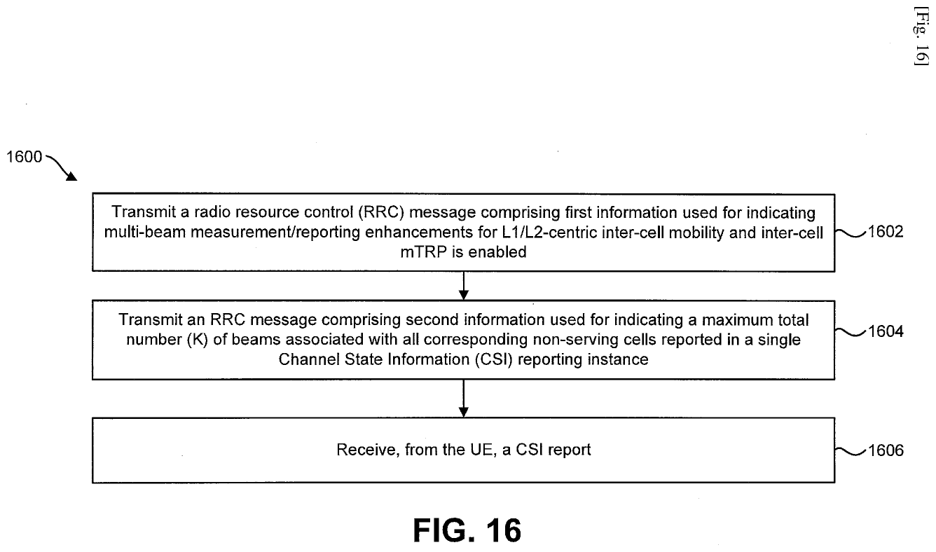

FIG. 16 is a flow diagram illustrating an example of a method 1600 of a base station for beam management with inter-cell mobility. The base station may transmit 1602 a radio resource control (RRC) message comprising first information used for indicating multi-beam measurement/reporting enhancements for L1/L2-centric inter-cell mobility and inter-cell mTRP is enabled. The base station may transmit 1604 an RRC message comprising second information used for indicating a maximum total number (K) of beams associated with all corresponding non-serving cells reported in a single Channel State Information (CSI) reporting instance. The base station may receive 1606, from the UE, a CSI report.

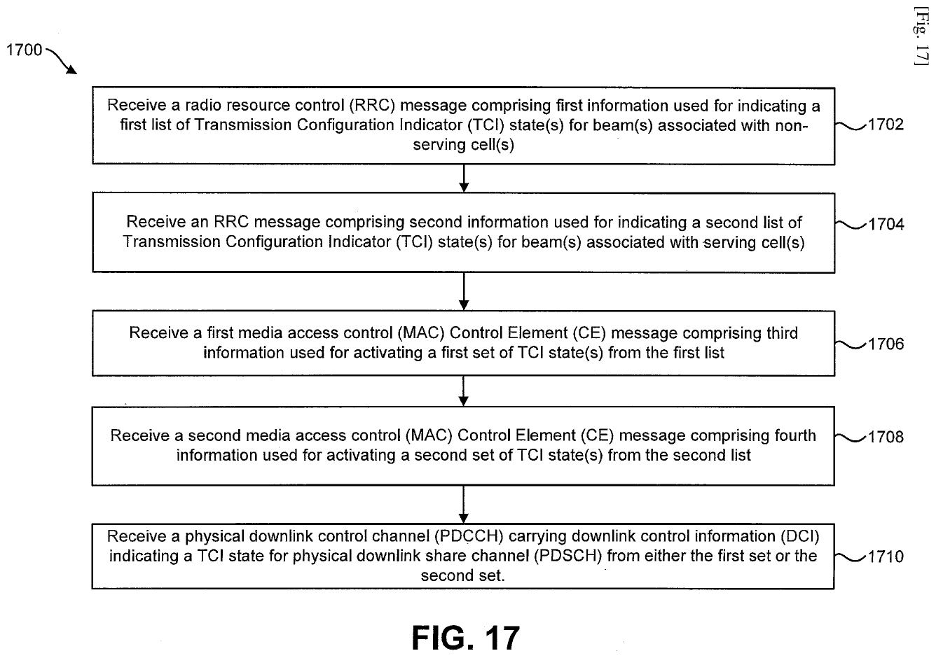

FIG. 17 is a flow diagram illustrating an example of a method 1700 of a UE for beam indication with inter-cell mobility for PDSCH. The UE may receive 1702 a radio resource control (RRC) message comprising first information used for indicating a first list of Transmission Configuration Indicator (TCI) state(s) for beam(s) associated with non-serving cell(s). The UE may receive 1704 an RRC message comprising second information used for indicating a second list of Transmission Configuration Indicator (TCI) state(s) for beam(s) associated with serving cell(s). Further, the UE may receive 1706 a first media access control (MAC) Control Element (CE) message comprising third information used for activating a first set of TCI state(s) from the first list. The UE may receive 1708 a second media access control (MAC) Control Element (CE) message comprising fourth information used for activating a second set of TCI state(s) from the second list. The UE may receive 1710 a physical downlink control channel (PDCCH) carrying downlink control information (DCI) indicating a TCI state for physical downlink share channel (PDSCH) from either the first set or the second set.

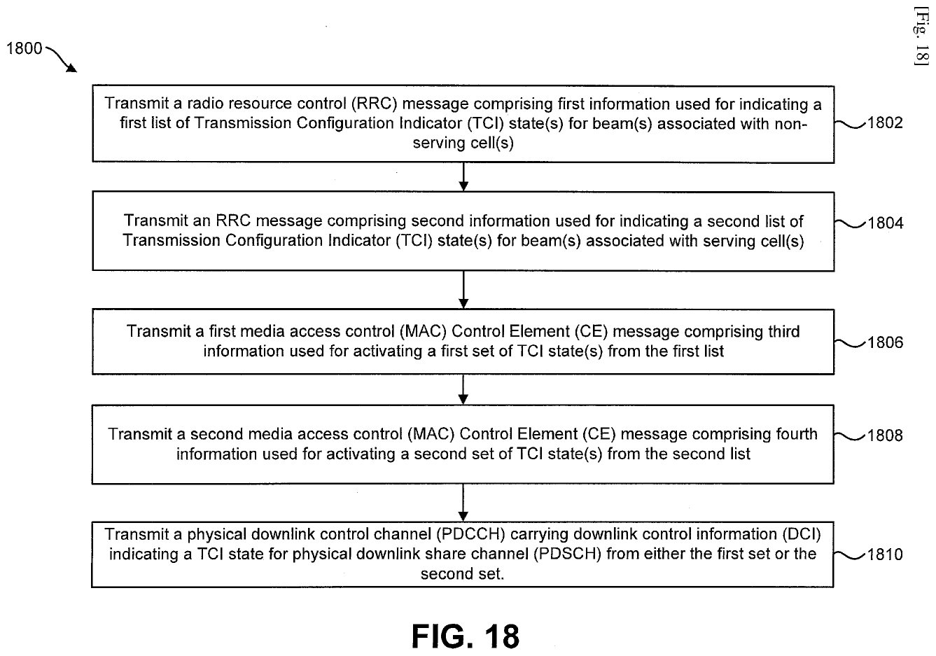

FIG. 18 is a flow diagram illustrating an example of a method 1800 of a base station for beam indication with inter-cell mobility for PDSCH. The base station may transmit 1802 a radio resource control (RRC) message comprising first information used for indicating a first list of Transmission Configuration Indicator (TCI) state(s) for beam(s) associated with non-serving cell(s). The base station may transmit 1804 an RRC message comprising second information used for indicating a second list of Transmission Configuration Indicator (TCI) state(s) for beam(s) associated with serving cell(s). Further, the base station may transmit 1806 a first media access control (MAC) Control Element (CE) message comprising third information used for activating a first set of TCI state(s) from the first list. The base station may transmit 1808 a second media access control (MAC) Control Element (CE) message comprising fourth information used for activating a second set of TCI state(s) from the second list. The base station may transmit 1810 a physical downlink control channel (PDCCH) carrying downlink control information (DCI) indicating a TCI state for physical downlink share channel (PDSCH) from either the first set or the second set.

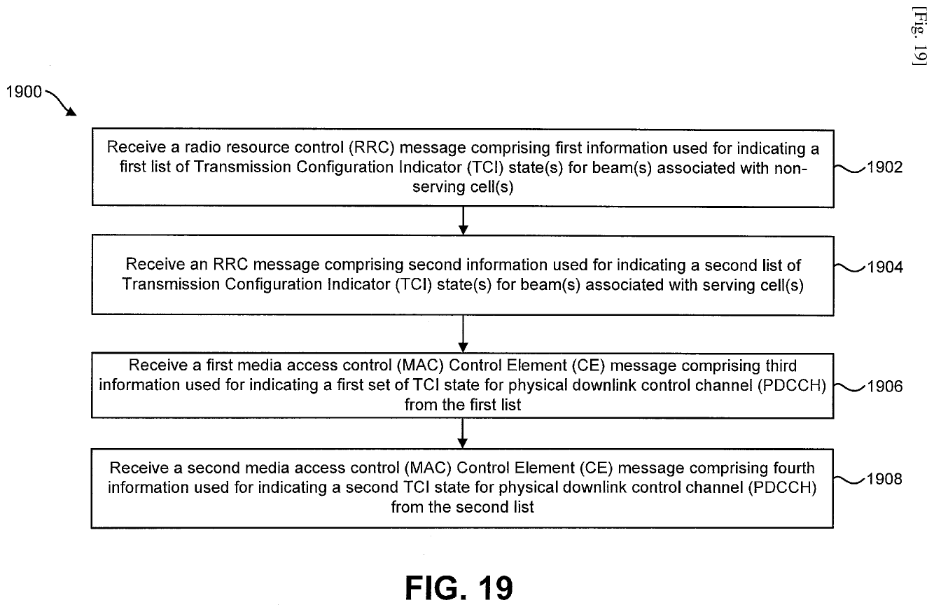

FIG. 19 is a flow diagram illustrating an example of a method 1900 of a UE for beam indication with inter-cell mobility for PDCCH. The UE may receive 1902 a radio resource control (RRC) message comprising first information used for indicating a first list of Transmission Configuration Indicator (TCI) state(s) for beam(s) associated with non-serving cell(s). The UE may receive 1904 an RRC message comprising second information used for indicating a second list of Transmission Configuration Indicator (TCI) state(s) for beam(s) associated with serving cell(s). Further, the UE may receive 1906 a first media access control (MAC) Control Element (CE) message comprising third information used for indicating a first TCI state for physical downlink control channel (PDCCH) from the first list. The UE may receive 1908 a second media access control (MAC) Control Element (CE) message comprising fourth information used for indicating a second TCI state for physical downlink control channel (PDCCH) from the second list.

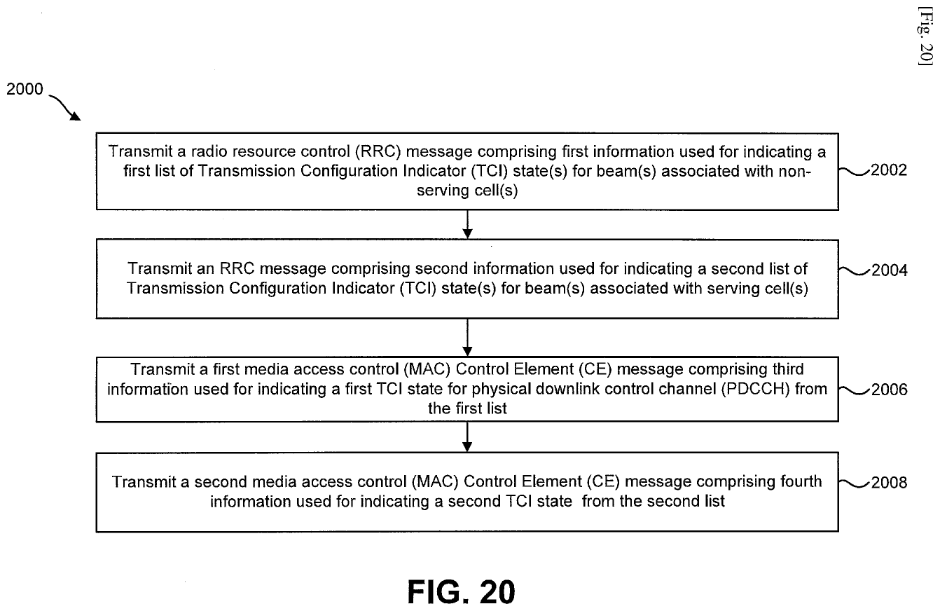

FIG. 20 is a flow diagram illustrating an example of a method 2000 of a base station for beam indication with inter-cell mobility for PDCCH. The base station may transmit 2002 a radio resource control (RRC) message comprising first information used for indicating a first list of Transmission Configuration Indicator (TCI) state(s) for beam(s) associated with non-serving cell(s). The base station may transmit 2004 an RRC message comprising second information used for indicating a second list of Transmission Configuration Indicator (TCI) state(s) for beam(s) associated with serving cell(s). Further, the base station may transmit 2006 a first media access control (MAC) Control Element (CE) message comprising third information used for indicating a first TCI state for physical downlink control channel (PDCCH) from the first list. The base station may transmit 2008 a second media access control (MAC) Control Element (CE) message comprising fourth information used for indicating a second TCI state for physical downlink control channel (PDCCH) from the second list.

The term “computer-readable medium” refers to any available medium that can be accessed by a computer or a processor. The term “computer-readable medium,” as used herein, may denote a computer-and/or processor-readable medium that is non-transitory and tangible. By way of example and not limitation, a computer-readable or processor-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer or processor. Disk and disc, as used herein, includes compact disc (CD), laser disc, optical disc, digital versatile disc (DVD), floppy disk and Blu-ray® disc where disks usually reproduce data magnetically, while discs reproduce data optically with lasers.

It should be noted that one or more of the methods described herein may be implemented in and/or performed using hardware. For example, one or more of the methods described herein may be implemented in and/or realized using a chipset, an application-specific integrated circuit (ASIC), a large-scale integrated circuit (LSI) or integrated circuit, etc.

Each of the methods disclosed herein comprises one or more steps or actions for achieving the described method. The method steps and/or actions may be interchanged with one another and/or combined into a single step without departing from the scope of the claims. In other words, unless a specific order of steps or actions is required for proper operation of the method that is being described, the order and/or use of specific steps and/or actions may be modified without departing from the scope of the claims.

It is to be understood that the claims are not limited to the precise configuration and components illustrated above. Various modifications, changes and variations may be made in the arrangement, operation and details of the systems, methods and apparatus described herein without departing from the scope of the claims.

A program running on the gNB 160 or the UE 102 according to the described systems and methods is a program (a program for causing a computer to operate) that controls a CPU and the like in such a manner as to realize the function according to the described systems and methods. Then, the information that is handled in these apparatuses is temporarily stored in a RAM while being processed. Thereafter, the information is stored in various ROMs or HDDs, and whenever necessary, is read by the CPU to be modified or written. As a recording medium on which the program is stored, among a semiconductor (for example, a ROM, a nonvolatile memory card, and the like), an optical storage medium (for example, a DVD, a MO, a MD, a CD, a BD and the like), a magnetic storage medium (for example, a magnetic tape, a flexible disk and the like) and the like, any one may be possible. Furthermore, in some cases, the function according to the described systems and methods described herein is realized by running the loaded program, and in addition, the function according to the described systems and methods is realized in conjunction with an operating system or other application programs, based on an instruction from the program.

Furthermore, in a case where the programs are available on the market, the program stored on a portable recording medium can be distributed or the program can be transmitted to a server computer that connects through a network such as the Internet. In this case, a storage device in the server computer also is included. Furthermore, some or all of the gNB 160 and the UE 102 according to the systems and methods described herein may be realized as an LSI that is a typical integrated circuit. Each functional block of the gNB 160 and the UE 102 may be individually built into a chip, and some or all functional blocks may be integrated into a chip. Furthermore, a technique of the integrated circuit is not limited to the LSI, and an integrated circuit for the functional block may be realized with a dedicated circuit or a general-purpose processor. Furthermore, if with advances in a semiconductor technology, a technology of an integrated circuit that substitutes for the LSI appears, it is also possible to use an integrated circuit to which the technology applies.

Moreover, each functional block or various features of the base station device and the terminal device used in each of the aforementioned embodiments may be implemented or executed by a circuitry, which is typically an integrated circuit or a plurality of integrated circuits. The circuitry designed to execute the functions described in the present specification may comprise a general-purpose processor, a digital signal processor (DSP), an application specific or general application integrated circuit (ASIC), a field programmable gate array (FPGA), or other programmable logic devices, discrete gates or transistor logic, or a discrete hardware component, or a combination thereof. The general-purpose processor may be a microprocessor, or alternatively, the processor may be a conventional processor, a controller, a microcontroller, or a state machine. The general-purpose processor or each circuit described herein may be configured by a digital circuit or may be configured by an analogue circuit. Further, when a technology of making into an integrated circuit superseding integrated circuits at the present time appears due to advancement of a semiconductor technology, the integrated circuit by this technology is also able to be used.

As used herein, the term “and/or” should be interpreted to mean one or more items. For example, the phrase “A, B and/or C” should be interpreted to mean any of: only A, only B, only C, A and B (but not C), B and C (but not A), A and C (but not B), or all of A, B, and C. As used herein, the phrase “at least one of” should be interpreted to mean one or more items. For example, the phrase “at least one of A, B and C” or the phrase “at least one of A, B or C” should be interpreted to mean any of: only A, only B, only C, A and B (but not C), B and C (but not A), A and C (but not B), or all of A, B, and C. As used herein, the phrase “one or more of” should be interpreted to mean one or more items. For example, the phrase “one or more of A, B and C” or the phrase “one or more of A, B or C” should be interpreted to mean any of: only A, only B, only C, A and B (but not C), B and C (but not A), A and C (but not B), or all of A, B, and C.

What is claimed is:

1. A user equipment (UE) that communicates with a base station apparatus, comprising:
receiving circuitry configured to:
receive a radio resource control (RRC) message comprising first information used for indicating a first list of Transmission Configuration Indicator (TCI) state(s) for non-zero power channel state information reference signal (CSI-RS) resource index(es) associated with non-serving cell(s);
receive an RRC message comprising second information used for indicating a second list of Transmission Configuration Indicator (TCI) state(s) for non-zero power channel state information reference signal (CSI-RS) resource index(es) associated with serving cell(s);
receive a first media access control (MAC) Control Element (CE) message comprising third information used for indicating a first TCI state for physical downlink control channel (PDCCH) from the first list; and
receive a second media access control (MAC) Control Element (CE) message comprising fourth information used for indicating a second TCI state for physical downlink control channel (PDCCH) from the second list.

2. A base station apparatus that communicates with a user equipment (UE), comprising:
transmitting circuitry configured to:
transmit a radio resource control (RRC) message comprising first information used for indicating a first list of Transmission Configuration Indicator (TCI) state(s) for non-zero power channel state information reference signal (CSI-RS) resource index(es) associated with non-serving cell(s);
transmit an RRC message comprising second information used for indicating a second list of Transmission Configuration Indicator (TCI) state(s) for non-zero power channel state information reference signal (CSI-RS) resource index(es) associated with serving cell(s);
transmit a first media access control (MAC) Control Element (CE) message comprising third information used for indicating a first TCI state for physical downlink control channel (PDCCH) from the first list; and
transmit a second media access control (MAC) Control Element (CE) message comprising fourth information used for indicating a second TCI state for physical downlink control channel (PDCCH) from the second list.

3. A communication method of a user equipment (UE) that communicates with a base station apparatus, comprising:
receiving a radio resource control (RRC) message comprising first information used for indicating a first list of Transmission Configuration Indicator (TCI) state(s) for non-zero power channel state information reference signal (CSI-RS) resource index(es) associated with non-serving cell(s);
receiving an RRC message comprising second information used for indicating a second list of Transmission Configuration Indicator (TCI) state(s) for non-zero power channel state information reference signal (CSI-RS) resource index(es) associated with serving cell(s);
receiving a first media access control (MAC) Control Element (CE) message comprising third information used for indicating a first TCI state for physical downlink control channel (PDCCH) from the first list;
receiving a second media access control (MAC) Control Element (CE) message comprising fourth information used for indicating a second TCI state for physical downlink control channel (PDCCH) from the second list;
receiving a radio resource control (RRC) message comprising fifth information used for indicating a third list of Transmission Configuration Indicator (TCI) state(s) for beam(s) associated with non-serving cell(s) and/or Transmission Configuration Indicator (TCI) state(s) for beam(s) associated with serving cell(s); and
receiving a third media access control (MAC) Control Element (CE) message comprising sixth information used for indicating a third TCI state for physical downlink control channel (PDCCH) from the third list.

4. A user equipment (UE) of claim 1, comprising:
receiving circuitry configured to:
receive a radio resource control (RRC) message comprising fifth information used for indicating a third list of Transmission Configuration Indicator (TCI) state(s) for beam(s) associated with non-serving cell(s) and/or Transmission Configuration Indicator (TCI) state(s) for beam(s) associated with serving cell(s); and
receive a third media access control (MAC) Control Element (CE) message comprising sixth information used for indicating a third TCI state for physical downlink control channel (PDCCH) from the third list.

5. A base station apparatus of claim 2, comprising:
transmitting circuitry configured to:
transmit a radio resource control (RRC) message comprising fifth information used for indicating a third list of Transmission Configuration Indicator (TCI) state(s) for beam(s) associated with non-serving cell(s) and/or Transmission Configuration Indicator (TCI) state(s) for beam(s) associated with serving cell(s); and
transmit a third media access control (MAC) Control Element (CE) message comprising sixth information used for indicating a third TCI state for physical downlink control channel (PDCCH) from the third list.
